(19) United States
(12) Patent Application Publication
(10) Pub. No.: US 2021/0332269 A1
(43) Pub. Date: Oct. 28, 2021

(54) RELEASE LAYERS AND ARTICLES CONTAINING THEM

(71) Applicant: 3M INNOVATIVE PROPERTIES COMPANY, St. Paul, MN (US)

(72) Inventors: Marie A. Boulos, West St. Paul, MN (US); Jitendra S. Rathore, Woodbury, MN (US); Maria A. Appeaning, St. Paul, MN (US); Georgiy Teverovskiy, St. Louis Park, MN (US); Scott M. LeBow, Woodbury, MN (US); Michael L. Steiner, New Richmond, WI (US); Chris J. Tanley, Stillwater, MN (US)

(21) Appl. No.: 17/309,619

(22) PCT Filed: Dec. 11, 2019
(86) PCT No.: PCT/IB2019/060659

§ 371 Date: Jun. 10, 2021

Related U.S. Application Data
(60) Provisional application No. 62/781,801, filed on Dec. 19, 2018.

(51) Int. Cl. C09J 7/40; C08G 77/16; C08G 77/18

(52) U.S. Cl. CPC C09J 7/401; C08G 77/16; C09J 2483/005; C09J 2301/416; C08G 77/18

(57) ABSTRACT

Release layers that can be included in various adhesive tape products and release liners for adhesive layers are provided. The release layer is a cured reaction product of a curable release composition that contains i) a siloxane polymer having at least two hydrolyzable groups and having a weight average molecular weight of at least 1000 Daltons, ii) a crosslinker, iii) a silane additive, iv) a photoacid generator, and v) an optional silicate resin. The crosslinker is a compound of formula Si(OR⁵)₄ or is a compound having at least two silyl groups of formula —Si(R⁴)x(OR⁵)₃-x where R⁴ is alkyl or aryl, R⁵ is alkyl, and the variable xis an integer equal to 0 or 1. The silane additive is a compound having two silyl groups of formula —Si(R⁶)₂(OR⁷) or a single silyl group of formula —Si(R¹⁰) (OR⁹)₂ where R⁶ is alkyl or aryl, R⁷ is alkyl, R⁹ is alkyl, and R¹⁰ is alkyl or aryl.

### BACKGROUND

Adhesive tape comes in many varieties such as, for example, single-sided or double-sided adhesive tape that is usually wound into a roll. Some adhesive tapes have a backing layer and an adhesive layer securely bonded to the backing layer. To facilitate unrolling of the adhesive tape, the side of the backing layer opposite the adhesive layer can have a release layer.

Some adhesive tapes are adhesive transfer tapes with an adhesive layer adjacent a release liner that protects the adhesive layer and that is removed prior to securely bonding the adhesive layer to a substrate. The release liner has a backing layer and a release layer on one or both surfaces of the backing layer. The release liner is positioned adjacent to the adhesive layer such that there is a release layer between the adhesive layer and the backing layer of the release liner. In some embodiments, the release liner has a second release layer that is positioned adjacent to the adhesive layer and a first release layer that is opposite the adhesive layer. This first release layer can facilitate unrolling the adhesive tape. This second release layer typically has different release properties towards the adhesive layer than the first release layer.

Release layers have been prepared by dissolving the release components in solvent, coating the resulting solution onto a surface of the backing layer, and drying to evaporate the solvent. One example of a release coating formed using a conventional solvent-based process is found in U.S. Pat. No. 2,532,011 (Dahlquist et al.). Solvent-based processes, however, have become increasingly less desirable due to special handling requirements and environmental concerns.

### SUMMARY

Release layers that can be included in various adhesive tape products and in release liners for adhesive tapes are provided. Advantageously, the release layers can retain stable release characteristics over time towards the adhesive. Further, the release layers can be exposed to electron beam radiation in the process of crosslinking an adjacent adhesive layer without significantly altering the release characteristics. Still further, the release layers advantageously can be formed using siloxane polymers with a weight average molecular weight (e.g., at least 1000 Daltons) that is higher than that used in some known release layers. The higher weight average molecular weight of the siloxane polymer can lead to reduced volatile content of the release layers (e.g., reduced volatile siloxane content).

In a first aspect, a release layer is provided that comprises a cured reaction product of a curable release composition that contains i) a siloxane polymer having a weight average molecular weight of at least 1000 Daltons, ii) a crosslinker, iii) a silane additive, iv) a photoacid generator, and v) an optional silicate resin. The siloxane polymer is of Formula (I).

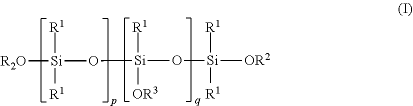

In Formula (I), R¹ is alkyl, R² is hydrogen or alkyl, and R³ is alkyl. Variable p is an integer equal to at least 10 and variable q is an integer in a range of 0 to 0.1(p). The crosslinker is a compound of formula Si(OR⁵)₄ or is a compound having at least two silyl groups of formula —Si(R⁴)ₓ(OR⁵)₃₋ₓ where R⁴ is alkyl or aryl, R⁵ is alkyl, and the variable x is an integer equal to 0 or 1. The silane additive is a compound having two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl.

In a second aspect, an article is provided that includes a) a backing layer having a first major surface and a second major surface opposite the first major surface and b) a first release layer adjacent to the first major surface of the backing layer. The first release layer comprises a first cured reaction product of a first curable release composition that contains i) a first siloxane polymer having a weight average molecular weight of at least 1000 Daltons, ii) a first crosslinker, iii) a first silane additive, iv) a first photoacid generator, and v) an optional first silicate resin. The first siloxane polymer is of Formula (I).

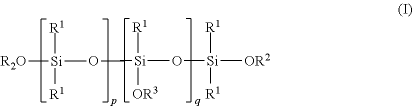

In Formula (I), R¹ is alkyl, R² is hydrogen or alkyl, and R³ is alkyl. Variable p is an integer equal to at least 10 and variable q is an integer in a range of 0 to 0.1(p). The first crosslinker is a compound of formula Si(OR⁵)₄ or is a compound having at least two silyl groups of formula —Si(R⁴)ₓ(OR⁵)₃₋ₓ where R⁴ is alkyl or aryl, R⁵ is alkyl, and the variable x is an integer equal to 0 or 1. The first silane additive is a compound having two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl.

In as third aspect, a method of making an article is provided. The method includes providing a backing having a first major surface and second major surface opposite the first major surface. The method further includes applying a first curable release composition adjacent to the first major surface of the backing. The first curable release composition is the same as described above in the second aspect. The method still further includes exposing the first curable release composition to ultraviolet radiation or electron beam radiation to form a first release layer.

### BRIEF DESCRIPTION OF THE DRAWINGS

FIG. 1 is a schematic of a vertical cross-section of an article having a backing and a release layer positioned adjacent to a first major surface of the backing.

FIG. 2 is a schematic of a vertical cross-section of an article having a backing and a release layer positioned adjacent to a first major surface and a second major surface of the backing.

FIG. 3 is a schematic of a vertical cross-section of an article having multiple layers and arranged in the following order: first release layer-backing-second release layer-adhesive layer.

FIG. 4 is a schematic of the article shown in FIG. 3 that is rolled.

FIG. 5 is a schematic of a vertical cross-section of an article having multiple layers and arranged in the following order: first release layer-backing-adhesive layer.

The various layers in the articles shown in the above figures are not drawn to scale and the dimensions shown in the figures are only for illustrative purposes.

### DETAILED DESCRIPTION

Release layers, various articles that contain the release layers, and methods of making the release layers and articles are provided. The release layers can be used in various adhesive tapes and/or release liners for adhesive compositions. Advantageously, the release layers can often be prepared in the absence of organic solvents and/or using siloxane polymers having a relatively low volatile content. Further, uncured adhesive layers can be cured with electron beam radiation or ultraviolet radiation while in contact with the release layers without significantly altering the release characteristics of the release layers.

The release layers contain a cured reaction product of a curable release composition that contains i) a siloxane polymer, ii) a crosslinker, iii) a silane additive, iv) a photoacid generator, and v) an optional silicate resin. The release layers are typically adjacent to at least one major surface of a backing layer. If there are two release layers (i.e., there is a release layer adjacent to a first and second major surface of the backing layer), the release layers often differ in how strongly they adhere to (i.e., how easily they can be released from) the adhesive layer. The strength of adhesion to (i.e., the ease of releasing from) the adhesive layer can be varied by altering the amount of the silicate resin in the release layer.

Articles are provided that include a backing layer and at least one release layer adjacent to a major surface of the backing layer. In some embodiments, the articles are adhesive tapes with a release layer positioned adjacent to a first major surface of a backing and an adhesive layer positioned adjacent to a second major surface of the backing adjacent opposite the release layer. That is, the adhesive tapes have an overall construction that is an adhesive layer-backing layer-release layer. In other embodiments, the articles are release liners with two release layers. That is, the release liners can have a backing layer with a first release layer adjacent to a first major surface of the backing layer and with a second release layer adjacent to a second major surface of the backing layer. The overall construction of the release liner is first release layer-backing layer-second release layer. The release liners can be used to form transfer adhesive tapes with an adhesive layer adjacent to the release liner. That is, the overall construction of the transfer adhesive tape is an adhesive layer-first release layer-backing layer-second release layer. The adhesive layer can be a single layer or can be a first layer of a multilayer adhesive construction.

As used herein, “a”, “an”, and “the” are used interchangeably and mean one or more.

The term “and/or” is used to indicate that one or both stated cases may occur, for example A and/or B includes, (A and B) and (A or B). That is, it is used to mean A alone, B alone, or both A plus B.

The term “alkyl” refers to a monovalent group that is a radical of an alkane. The alkyl can have at least 1, at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkyl can be linear, branched, cyclic, or a combination thereof. A linear alkyl has at least one carbon atoms while a cyclic or branched alkyl has at least 3 carbon atoms. In some embodiments, if there are greater than 12 carbon atoms, the alkyl is branched. Examples of linear alkyl groups include methyl, ethyl, n-propyl, n-butyl, n-pentyl, n-hexyl, n-heptyl, and n-octyl groups. Examples of branched alkyl groups include iso-propyl, iso-butyl, sec-butyl, t-butyl, neopentyl, iso-pentyl, and 2,2-dimethylpropyl groups. Examples of cycloalkyl groups include cyclopropyl, cyclobutyl, cyclopentyl, and cyclohexyl.

The term “alkoxy” refers to a monovalent group of formula —OR^{a} where R^{a} is an alkyl as defined above.

The term “alkylene” refers to a divalent group that is a radical of an alkane. The alkylene can have at least 2, at least 3, at least 4, at least 6, or at least 10 carbon atoms and can have up to 32 carbon atoms, up to 24 carbon atoms, up to 20 carbon atoms, up to 18 carbon atoms, up to 12 carbon atoms, up to 10 carbon atoms, up to 6 carbon atoms, or up to 4 carbon atoms. The alkylene can be linear, branched, cyclic, or a combination thereof. A linear alkylene has at least one carbon atoms while a cyclic or branched alkylene has at least 3 carbon atoms. In some embodiments, if there are greater than 12 carbon atoms, the alkyl is branched. Examples of linear alkylene groups include methylene, ethylene, n-propylene, n-butylene, n-pentylene, n-hexylene, n-heptylene, and n-octylene groups. Examples of branched alkyl groups include iso-propylene, iso-butylene, sec-butylene, t-butylene, neo-pentylene, iso-pentylene, and 2,2-dimethylpropylene groups.

The term “heteroalkyl” refers to an alkyl group where at least one of the catenated carbon atoms (i.e., a carbon in the chain, more specifically a —CH₂— group in the chain) is replaced with oxy, thio, or —NH—. That is, the heteroatom is positioned between two carbon atoms.

The term “heteroalkylene” refers to an alkylene group where at least one of the catenated carbon atoms (i.e., a carbon in the chain, more specifically a —CH₂— group in the chain) is replaced with oxy, thio, or —NH—. That is, the heteroatom is positioned between two carbon atoms.

The term “aryl” refers to a monovalent group that is a radical of an aromatic carbocyclic compound. The aryl group has at least one aromatic carbocyclic ring and can have 1 to 5 optional rings that are connected to or fused to the aromatic carbocyclic ring. The additional rings can be aromatic, aliphatic, or a combination thereof. The aryl group usually has 5 to 20 carbon atoms or 6 to 10 carbon atoms. The aryl is often phenyl or diphenyl.

The term “arylene” refers to a divalent group that is a radical of an aromatic carbocyclic compound. The arylene group has at least one aromatic carbocyclic ring and can have 1 to 5 optional rings that are connected to or fused to the aromatic carbocyclic ring. The additional rings can be aromatic, aliphatic, or a combination thereof. The arylene group usually has 5 to 20 carbon atoms or 6 to 10 carbon atoms. The arylene is often phenylene or diphenylene.

The term “(meth)acrylate” refers to acrylate, methacrylate, or both.

The terms “in a range of” or “in the range of” are used interchangeably to refer to all values within the range plus the endpoints of the range.

In a first aspect, a release layer comprises a cured reaction product of a curable release composition that contains i) a siloxane polymer having a weight average molecular weight of at least 1000 Daltons, ii) a crosslinker, iii) a silane additive, iv) a photoacid generator, and v) an optional silicate resin.

The siloxane polymer included in the curable release composition is of Formula (I).

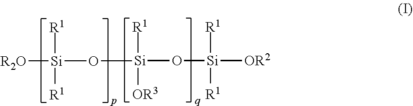

In Formula (I), R¹ is alkyl, R² is hydrogen or alkyl, and R³ is alkyl. Variable p is an integer equal to at least 10 and variable q is an integer in a range of 0 to 0.1(p).

Suitable alkyl groups for R¹, R², and R³ often have 1 to 10 carbon atoms, 1 to 6 carbon atoms, 1 to 4 carbon atoms, or 1 to 3 carbon atoms. In many embodiments, R¹ is methyl and both R² and R³ have 1 to 4 carbon atoms or 1 to 3 carbon atoms. In some examples, R² and R³ are independently methyl or ethyl.

The variable p in Formula (I) is equal to at least 10. The upper limit of variable p can be up to 7000 or even higher. For example, p can be at least 15, at least 20, at least 30, at least 40, at least 50, at least 80, at least 100, at least 200, at least 300, at least 500, or at least 1000 and up to 7000, up to 6000, up to 5000, up to 4000, up to 3000, or up to 2000, up to 1000, up to 500, up to 300, up to 200, up to 100, or up to 50. The siloxane polymer is often a mixture of various compounds having different molecular weights. If p is too low, the resulting release layer may have an unacceptable volatile content (i.e., an unacceptable amount of volatile siloxane compounds such as D3-D6 cyclic siloxane compounds may be included in the siloxane polymer). That is, if the siloxane polymer is not completely cured, the siloxane polymer (or low molecular weight compounds included in a siloxane polymer) may be volatile under certain process conditions used in preparing the release layer. Human exposure to these volatile compounds is undesirable. On the other hand, if p is too large, the siloxane polymer may have a viscosity that is too high to be used without dilution by an organic solvent. While using organic solvents may be acceptable for some applications, they may be undesirable for other applications where low volatile content is desired.

The siloxane polymer often has two alkoxy groups of formula —OR² at the terminal positions. In such polymers, q is equal to zero. In some embodiments, there are additional alkoxy groups along the polymeric chain. In such polymers, q is an integer equal to 0.1(p). As the molecular weight of the polymer increases, the value of q can increase. The variable q is often no greater than 700, no greater than 600, no greater than 400, no greater than 200, no greater than 100, no greater than 50, no greater than 20, no greater than 10, or no greater than 5. In some embodiments, the variable q is in a range of 0 to 100, 1 to 100, 0 to 50, 1 to 50, 0 to 20, 1 to 20, 0 to 10, 1 to 10, 0 to 5, or 1 to 5. Where q is at least 1, the siloxane polymer can be a random or block copolymer.

The weight average molecular weight (Mw) of the siloxane polymer can be in a range of 1000 to 500,000 Daltons. The weight average molecular weight can be at least 1500 Daltons, at least 2000 Daltons, at least 2500 Daltons, at least 3000 Daltons, at least 4000 Daltons, at least 5000 Daltons, or at least 10,000 Daltons and up to 500,000 Daltons, up to 200,000 Daltons, up to 100,000 Daltons, up to 50,000 Daltons, up to 40,000 Daltons, up to 30,000 Daltons, up to 20,000 Daltons, up to 10,000 Daltons, or up to 5,000 Daltons. If it is desirable to avoid the use of organic solvents to decrease the viscosity of the curable release composition and/or to minimize the volatile content, the weight average molecular weight of the siloxane polymer is often selected to be no greater than 50,000 Daltons. The weight average molecular weight can be determined using gel permeation chromatography (GPC).

The curable release composition often contains at least 20 weight percent of the siloxane polymer of Formula (I) based on the total weight of the curable release composition. The amount can be, for example, at least 25 weight percent, at least 30 weight percent, at least 35 weight percent, at least 40 weight percent, at least 45 weight percent, at least 50 weight percent, at least 55 weight percent, or at least 60 weight percent and can be up to 95 weight percent, up to 90 weight percent, up to 85 weight percent, up to 80 weight percent, or up to 75 weight percent. For example, the amount can be in a range of 20 to 95 weight percent, 20 to 90 weight percent, 20 to 85 weight percent, 30 to 85 weight percent, 40 to 85 weight percent, 50 to 85 weight percent, 60 to 85 weight percent, or 60 to 80 weight percent based on the total weight of the curable release composition.

The curable release composition further includes a crosslinker that is a compound of formula Si(OR⁵)₄ or a compound having at least two silyl groups of formula —Si(R⁴)ₓ(OR⁵)₃₋ₓ where R⁴ is alkyl or aryl, R⁵ is alkyl, and the variable x is an integer equal to 0 or 1. Suitable alkyl groups for R⁴ and R⁵ often have 1 to 10 carbon atoms, 1 to 6 carbon atoms, 1 to 4 carbon atoms, 1 to 3 carbon atoms, or 1 to 2 carbon atoms. Suitable aryl groups for R⁴ often have 6 to 12 carbon atoms or 6 to 10 carbon atoms. The aryl is often phenyl. Each silyl group can react with at least two other alkoxy and/or hydroxy groups such as alkoxy and/or hydroxy groups on the siloxane polymer of Formula (I). Reacting more than two alkoxy and/or hydroxy groups of the crosslinker results in crosslinking rather than chain extension.

In some embodiments, the crosslinker is of formula Si(OR⁵)₄. Examples include tetramethoxysilane, tetraethoxysilane, and tetrapropoxysilane.

In other embodiments, the crosslinker is of Formula (II).

(OR⁵)₃₋ₓ(R⁴)ₓSi—R⁸—Si(R⁴)ₓ(OR⁵)₃₋ₓ (II)

In Formula (II), group R⁸ is oxy, a group of formula —O—[Si(CH₃)₂—O]ₘ—, an alkylene, a heteroalkylene, a heteroalkylene substituted with a hydroxyl group, an arylene, a fluorine substituted arylene, or an alkylene-arylene-alkylene group. The variable m is an integer in a range of 1 to 10. R⁴, R⁵, and variable x are the same as described above. If x is equal to 0, then Formula (II) is of Formula (II-A).

(OR⁵)₃Si—R⁸—Si(OR⁵)₃ (II-A)

If x is equal to 1, then Formula (II) is of Formula (II-B).

(OR⁵)₂(R⁴)Si—R⁸—Si(R⁴)(OR⁵)₂ (II-B)

If group R⁸ in Formula (II) is oxy, then the crosslinker is of Formula (II-1).

(OR⁵)₃₋ₓ(R⁴)ₓSi—O—Si(R⁴)ₓ(OR⁵)₃₋ₓ (II-1)

Examples of such crosslinkers include, but are not limited to, (CH₃CH₂O)₃Si—O—Si(OCH₂CH₃)₃, (CH₃O)₃Si—O—Si(OCH₃)₃, (CH₃CH₂O)₂(CH₃)Si—O—Si(CH₃)(OCH₂CH₃)₂, and (CH₃O)₂(CH₃)Si—O—Si(CH₃)(OCH₃)₂.

If group R⁸ in Formula (II) is an alkylene, the alkylene often has 1 to 12 carbon atoms, 1 to 10 carbon atoms, 1 to 6 carbon atoms, 1 to 4 carbon atoms, or 1 to 3 carbon atoms. Examples include, but are not limited to, (CH₃CH₂O)₃Si—C₂H₄—Si(OCH₂CH₃)₃, (CH₃CH₂O)₂(CH₃)Si—C₂H₄—Si(CH₃)(OCH₂CH₃)₂, (CH₃O)₃Si—C₂H₄—Si(OCH₃)₃, (CH₃O)₂(CH₃)Si—C₂H₄—Si(CH₃)(OCH₃)₂, (CH₃CH₂O)₃Si—C₄H₈—Si(OCH₂CH₃)₃, (CH₃CH₂O)₃Si—C₆H₁₂—Si(OCH₂CH₃)₃, (CH₃CH₂O)₃Si—C₈H₁₆—Si(OCH₂CH₃)₃, (CH₃CH₂O)₂(CH₃)Si—C₈H₁₆—Si(OCH₂CH₃)₂(CH₃), and (CH₃CH₂O)₃Si—C₁₀H₂₀—Si(OCH₂CH₃)₃. The two silyl groups do not need to be in the terminal positions of the alkylene but can be on any carbon atom such as in 1,2-bis(trimethoxysilyl)decane or even on the same carbon atoms such as in bis(trimethoxysilyl)methane and bis(triethoxysilyl)methane.

If groups R⁸ in Formula (II) is a heteroalkylene or a heteroalkylene substituted with a hydroxyl group, the heteroalkylene often has one or more heteroatoms selected from —S—, —O—, or —NH—. In some examples, there can be 1 to 5 heteroatoms, 1 to 3 heteroatoms, or 1 to 2 heteroatoms and 2 to 20 carbon atoms, 2 to 16 carbon atoms, 2 to 12 carbon atoms, 2 to 10 carbon atoms, or 2 to 6 carbon atoms. Examples include, but are not limited to, bis[3-(trimethoxysilyl)propyl]amine and 1,11-bis(trimethoxysilyl)-4-oxa-8-azaundecan-6-ol.

If group R⁸ in Formula (II) is an arylene, the arylene often has 6 to 12 carbon atoms. The arylene optionally can be substituted with one or more fluorine atoms. In some embodiments, the arylene is phenylene or diphenylene. The fluorinated arylene is often phenylene substituted with 1 to 4 fluorine atoms (e.g., tetrafluorophenylene). The groups —Si(R⁴)ₓ(OR⁵)₃₋ₓ can be positioned in an ortho, meta, or para positions relative to each other on the same aromatic ring or on different aromatic rings. Examples include, but are not limited to, (CH₃CH₂O)₃Si—C₆H₄—Si(OCH₂CH₃)₃, (CH₃CH₂O)₂(CH₃)Si—C₆H₄—Si(CH₃)(OCH₂CH₃)₂, (CH₃CH₂O)₃Si—C₆H₄—C₆H₄—Si(OCH₂CH₃)₃, (CH₃CH₂O)₂(CH₃)Si—C₆H₄—C₆H₄—Si(CH₃)(OCH₂CH₃)₂, 1,4-bis(triethoxysilyl)tetrafluorobenzene, 1,4 bis(trimethoxysilyl)tetrafluorobenzene, and 1,4 bis(triethoxysilyl)-2,3-difluorobenzene.

If group R⁸ in Formula (II) is an alkylene-arylene-alkylene group, each alkylene often contains 1 to 10 carbon atoms, 1 to 6 carbon atoms, 1 to 4 carbon atoms, or 1 to 3 carbon atoms and each arylene group often contains 6 to 12 carbon atoms. The arylene is often phenylene. Examples include, but are not limited to, 1,4-bis(trimethoxysilylmethyl)benzene and 1,4-bis(triethoxysilylethyl)benzene.

If group R⁸ in Formula (II) is a group of formula —O—[Si(CH₃)₂—O]ₘ—, the variable m is in a range of 1 to 10, 1 to 6, to 1 to 4, or 1 to 2. In many examples, m is equal to 1 such as in example crosslinkers (CH₃CH₂O)₃Si—O—Si(CH₃)₂—O—Si(OCH₂CH₃)₃, (CH₃CH₂O)₂(CH₃)Si—O—Si(CH₃)₂—O—Si(CH₃)(OCH₂CH₃)₂, (CH₃O)₃Si—O—Si(CH₃)₂—O—Si(OCH₃)₃, and (CH₃O)₂(CH₃)Si—O—Si(CH₃)₂—O—Si(CH₃)(OCH₃)₂.

The curable release composition often contains at least 1 weight percent of the crosslinker based on the total weight of the curable release composition. If less is used, the composition may not cure sufficiently or may cure too slowly when exposed to ultraviolet radiation. The amount of the crosslinker can be up to 20 weight percent based on the total weight of the curable release composition. If more is used, the release layer may not release readily from an adhesive composition positioned adjacent to the release layer. That is, the adhesive layer may adhere too strongly to the release layer. The amount of the crosslinker can be at least 2 weight percent, at least 3 weight percent, at least 5 weight percent, at least 8 weight percent, or at least 10 weight percent and up to 20 weight percent, up to 15 weight percent, up to 13 weight percent, up to 12 weight percent, up to 10 weight percent, or up to 5 weight percent. In some embodiments, the curable release composition contains 1 to 20 weight percent, 1 to 15 weight percent, 5 to 20 weight percent, 5 to 15 weight percent, 5 to 10 weight percent, 8 to 20 weight percent, 8 to 15 weight percent, or 10 to 20 weight percent crosslinker based on the total weight of the curable release composition.

The curable release composition further contains a silane additive. The silane additive can be used to minimize the haze of the curable release composition without the use of an organic solvent (or with the use of a decreased amount of the organic solvent). That is, the silane additive can facilitate the formation of a single phase curable release composition without the addition of an organic solvent (or with the use of a decreased amount of the organic solvent). The haze and undesirable second phase is often due to incomplete dissolution of the photoacid generator in the curable release composition. The silane additive typically can effectively facilitate dissolution of the photoacid generator in the curable release composition, particularly for curable release compositions that contain siloxane polymers having a weight average molecular weight that is at least 1000 Daltons.

As used herein, the term “organic solvent” refers to a compound that is added to lower the viscosity of the curable release composition but that does not react with the other components. Like an organic solvent, the silane additive can lower the viscosity of the curable release composition but it reacts with other components in the composition. That is, the silane additive can react with the siloxane polymer and/or the crosslinker in the curable release composition. By reacting, the silane additive is less prone than an organic solvent to contribute to the volatile content of the final cured release layer. Thus, both the use of a siloxane polymer with a weight average molecular weight of at least 1000 Daltons in combination with a silane additive that is reactive with other components of the curable release composition contributes to an overall reduction in volatile content of the resulting release layers. Unlike the crosslinker, however, the silane additive tends to react to extend chains rather than to crosslink chains. Thus, the addition of the silane additive serves a different function than the crosslinker in the curable release composition.

The silane additive has two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl. The silane additive contributes to chain extension of the siloxane polymer and typically does not contribute significantly to the crosslinking of the siloxane polymer. Suitable alkyl groups for R⁶ R⁷, R⁹, and R¹⁰ often have 1 to 10 carbon atoms, 1 to 6 carbon atoms, 1 to 4 carbon atoms, or 1 to 3 carbon atoms. Suitable aryl groups for R⁶ and R¹⁰ have 6 to 12 carbon atoms, 6 to 10 carbon atoms, or 6 carbon atoms. The aryl is often phenyl. Each silane additive can react with two other alkoxy and/or hydroxy groups.

In some embodiments, the silane additive is of is of Formula (III).

(R⁷O)(R⁶)₂Si—R¹¹—Si(R⁶)₂(OR⁷) (III)

In Formula (III), group R¹¹ is oxy, a group of formula —O—[Si(CH₃)₂—O]ₙ—, an alkylene, an arylene, a fluorinated arylene, or a alkylene-arylene-alkylene group. The variable n is an integer in a range of 1 to 10.

If R¹¹ in Formula (III) is an oxy, then the silane additive is of Formula (III-1).

(R⁷O)(R⁶)₂Si—O—Si(R⁶)₂(OR⁷) (III-1)

Examples include (CH₂CH₃O)(CH₃)₂Si—O—Si(CH₃)₂(OCH₂CH₃) and (CH₃O)(CH₃)₂Si—O—Si(CH₃)₂(OCH₃).

If R¹¹ in Formula (III) is an alkylene, the alkylene often has 1 to 12 carbon atoms, 1 to 10 carbon atoms, 1 to 6 carbon atoms, 1 to 4 carbon atoms, or 1 to 3 carbon atoms. Examples include, but are not limited to, (CH₂CH₃O)(CH₃)₂Si—CH₂CH₂—Si(CH₃)₂(OCH₂CH₃) and (CH₃O)(CH₃)₂Si—CH₂CH₂—Si(CH₃)₂(OCH₃).

If R¹¹ in Formula (III) is an arylene, the arylene often has 6 to 12 carbon atoms. The arylene optionally can be substituted with one or more fluorine atoms (i.e., a fluorinated arylene). In some embodiments, R¹¹ is phenylene, phenylene substituted with 1 to 4 fluorine atoms (e.g., tetrafluorophenylene), or diphenylene. Examples include, but are not limited to, (CH₃CH₂O)(CH₃)₂Si—C₆H₄—Si(CH₃)₂(OCH₂CH₃), (CH₃CH₂O)(CH₃)₂Si—C₆F₄—Si(CH₃)₂(OCH₂CH₃), (CH₃O)(CH₃)₂Si—C₆H₄—Si(CH₃)₂(OCH₃), and (CH₃O)(CH₃)₂Si—C₆F₄—Si(CH₃)₂(OCH₃).

If R¹¹ in Formula (III) is an alkylene-arylene-alkylene, the arylene often has 6 to 12 carbon atoms and each alkylene often has 1 to 10 carbon atoms, 1 to 6 carbon atoms, or 1 to 4 carbon atoms. The arylene is often phenylene. One example is bis(ethoxydimethylsilyl)-1,4-diethylbenzene.

If R¹¹ in Formula (III) is of formula —O—[Si(CH₃)₂—O]ₙ—, n can be in a range of 1 to 10, 1 to 6, 1 to 4, 1 to 3, or 1 to 2. In many embodiments, n is equal to 1 such as in the silane additives (CH₃O)(CH₃)₂Si—O—Si(CH₃)₂—O—Si(CH₃)₂(OCH₃) and (CH₃CH₂O)(CH₃)₂Si—O—Si(CH₃)₂—O—Si(CH₃)₂(OCH₂CH₃).

In other embodiments, the silane additive is of Formula (IV).

R¹²—Si(R¹⁰)(OR⁹)₂ (IV)

In Formula (IV), R⁹ is alkyl, R¹⁰ is alkyl or aryl, and R¹² is alkyl, aryl, or a group of formula —R¹³—Si(R¹⁴)₃ where R¹³ is alkylene and each R¹⁴ is independently alkyl. Suitable alkyl groups for R⁹, R¹⁰, R¹², and R¹⁴ and alkylene groups for R¹³ usually have 1 to 10 carbon atoms, 1 to 6 carbon atoms, or 1 to 4 carbon atoms. Suitable aryl groups for R¹⁰ and R¹² usually have 6 to 12 carbon atoms, 6 to 10 carbon atoms, or 6 carbon atoms. The aryl is often phenyl.

Examples of silane additives of Formula (IV) where R¹⁰ and R¹² are each an alkyl include, but are not limited to, dimethyldiethoxysilane and dimethyldimethoxysilane. An example of a silane additive where R¹⁰ is aryl and R¹² is an alkyl (or where R¹⁰ is an alkyl and R¹² is an aryl) is methylphenyldimethoxysilane. An example where both R¹⁰ and R¹² are an aryl is diphenyldimethoxysilane. Examples of silane additives where R¹² is of formula —R¹³—Si(R¹⁴)₃ include, but are not limited to, (1-triethylsilyl-4-diethoxymethylsilyl)ethane and (1-triethylsilyl-4-dimethoxymethylsilyl)ethane.

The curable release composition includes at least 1 weight percent of the silane additive. If the amount is less, there may not be sufficient silane additive to dissolve the photoacid generator and the composition may appear hazy. If the photoacid generator is not dissolved, it tends not to be effective as an initiator. The upper amount of silane additive in the curable release composition is often 50 weight percent based on the total weight of the curable release composition. If the amount is greater, the release layer may adhere too strongly to the adhesive layer and/or the curing rate may be unacceptably slow because there is an insufficient amount of the crosslinker. The amount of the silane additive can be at least 2 weight percent, at least 4 weight percent, at least 5 weight percent, at least 10 weight percent, at least 12 weight percent, at least 15 weight percent, or at least 20 weight percent and up to 50 weight percent, up to 45 weight percent, up to 40 weight percent, up to 35 weight percent, up to 30 weight percent, up to 25 weight percent, up to 20 weight percent, or up to 15 weight percent based on the total weight of the curable release coating. In some examples, the amount of the silane additive is in a range of 1 to 50 weight percent, 5 to 50 weight percent, 10 to 50 weight percent, 10 to 45 weight percent, 10 to 40 weight percent, 10 to 30 weight percent, 12 to 30 weight percent, or 15 to 30 weight percent.

The curable release composition further includes a photoacid generator. Photoacid generators are typically salts that undergo irreversible photodissociation to form an acid upon absorption of light in the ultraviolet and/or visible region of the electromagnetic spectrum. The photoacid generators are typically onium salts. Suitable onium salt photoacid generators useful in practice of the present disclosure are known and are available from commercial suppliers and/or made can be prepared by known methods such as those described, for example, in Kirk-Othmer Encyclopedia of Chemical Technology, 4th Edition, Supplement Volume, John Wiley and Sons, New York, 1998, pp. 253-255.

Cations useful as the cationic portion of the onium salt photoacid generators include organic onium cations such as, for example, those described in U.S. Pat. No. 3,708,296 (Schlesinger), U.S. Pat. No. 4,069,055 (Crivello), U.S. Pat. No. 4,216,288 (Crivello), U.S. Pat. No. 4,250,311 (Crivello), U.S. Pat. No. 5,554,664 (Lamanna et al.), and U.S. Pat. No. 4,677,137 (Bany et al.). The cations are typically aliphatic or aromatic I-, S-, P-, and N-centered onium salts. The onium salt photoacid generators typically include sulfoxonium, iodonium, sulfonium, pyridinium, or phosphonium cations.

In many embodiments, the onium salts have cations such as those selected from sulfoxonium, diaryliodonium, triarylsulfonium, diarylalkylsulfonium, dialkylarylsulfonium, and trialkylsulfonium wherein for these compounds the terms “aryl” and “alkyl” mean an unsubstituted or substituted aromatic or aliphatic moiety, respectively, having up to four independently selected substituents. The substituents on the aryl or alkyl moieties will preferably have less than 30 carbon atoms and up to 10 heteroatoms selected from N, S, non-peroxidic O, P, Si, and B. Examples include hydrocarbyl groups such as methyl, ethyl, butyl, dodecyl, tetracosanyl, benzyl, allyl, benzylidene, ethenyl and ethynyl; hydrocarbyloxy groups such as methoxy, butoxy and phenoxy; hydrocarbylmercapto groups such as methylmercapto and phenylmercapto; hydrocarbyloxycarbonyl groups such as methoxycarbonyl and phenoxycarbonyl; hydrocarbylcarbonyl groups such as formyl, acetyl and benzoyl; hydrocarbylcarbonyloxy groups such as acetoxy and cyclohexanecarbonyloxy; hydrocarbylcarbonamido groups such as acetamido and benzamido; azo; boryl; halo groups such as chloro, bromo, iodo and fluoro; hydroxy; carbonyl; trimethylsiloxy; and aromatic groups such as cyclopentadienyl, phenyl, tolyl, naphthyl, and indenyl. With the sulfonium salts, it is possible for the substituent to be further substituted with a dialkyl- or diarylsulfonium cation; an example of this would be 1,4-phenylene-bis(diphenylsulfonium).

The anion in the onium salt photoacid generator is selected to provide solubility of the onium salt photoacid generator in organic solvent and compositions, although this is not a requirement. Exemplary preferred anions include PF₆⁻, SbF₆⁻, SbF₅OH⁻, Ph₄B⁻, and (PhF₅)₄B⁻ where Ph refers to phenyl.

Some onium salt photoacid generators are diaryliodonium salts, triarylsulfonium salts, and triarylsulfoxonium salts. Specific examples include bis(4-t-butylphenyl)iodonium hexafluoroantimonate (e.g., as available as FP5034 from Hampford Research Inc., Stratford, Conn.), a mixture of triarylsulfonium salts (diphenyl(4-phenylthio)phenylsulfonium hexafluoroantimonate and bis(4-(diphenylsulfonio)phenyl) sulfide hexafluoroantimonate) (e.g., available as UVI-6976 from Synasia Metuchen, N.J.), (4-methoxyphenyl)phenyl iodonium triflate, bis(4-tert-butylphenyl)iodonium camphorsulfonate, bis(4-dodecylphenyl)iodonium triflate, bis(4-dodecylphenyl)iodonium hexafluoroantimonate (e.g., available as CAS number 71786-70-4 from various manufacturers), bis(4-tert-butylphenyl)iodonium hexafluorophosphate, bis(4-tert-butylphenyl)iodonium tetraphenylborate, bis(4-tert-butylphenyl)iodonium tosylate, bis(4-tert-butylphenyl)iodonium triflate, ([4-(octyloxy)phenyl]phenyliodonium hexafluorophosphate), ([4-(octyloxy)phenyl]phenyliodonium hexafluoroantimonate), (4-isopropylphenyl)(4-methylphenyl)iodonium tetrakis(pentafluorophenyl) borate (e.g., as available as RHODORSIL 2074 from Bluestar Silicones, East Brunswick, N.J.), bis(4-methylphenyl)iodonium hexafluorophosphate (e.g., as available as OMNICAT 440 from IGM Resins Bartlett, Ill.), 4-[(2-hydroxy-1-tetradecycloxy)phenyl]phenyliodonium hexafluoroantimonate, triphenylsulfonium hexafluoroantimonate (e.g., as available as CT-548 from Chitec Technology Corp., Taipei, Taiwan), diphenyl(4-phenylthio)phenylsulfonium hexafluorophosphate, bis(4-(diphenylsulfonio)phenyl)sulfide bis(hexafluorophosphate), diphenyl(4-phenylthio)-phenylsulfonium hexafluoroantimonate, bis(4-(diphenylsulfonio)phenyl) sulfide hexafluoroantimonate, and blends of these triarylsulfonium salts (e.g., as available from Synasia, Metuchen, N.J. as UVI-6992 and UVI-6976 for the PF₆⁻ and SbF₆⁻ salts, respectively).

Some preferred onium salt photoacid generators are diaryliodonium salts and triarylsulfonium salts described by the formulas: (R¹⁵)₂I⁺SbF₆⁻, (R¹⁵)₂I⁺SbF₅OH⁻, (R¹⁵)₂I⁺B(PhF₅)₄⁻, (R¹⁵)₂I⁺PF₆⁻, (R¹⁵)₃S⁺SbF₆⁻, (R¹⁵)₃S⁺SbF₅OH⁻, (R¹⁵)₃S⁺B(PhF₅)₄⁻, and (R¹⁵)₃S⁺PF₆⁻, and where each R¹⁵ is independently an aryl (e.g., phenyl) or a substituted aryl group (e.g., an aryl substituted with an alkyl such as 4-dodecylphenyl, methylphenyl, and ethylphenyl or an aryl substituted with a —SO₂Ph group such as PhSO₂Ph- where Ph is phenyl) having from 6 to 18 carbon atoms, 6 to 12 carbon atoms, or 6 to 10 carbon atoms. Such materials can be obtained from commercial suppliers and/or synthesized by known methods.

The amount of the photoacid generator is often in a range of 0.25 to 10 weight percent based on the total weight of the curable release composition. If the amount is too low, the composition will not cure sufficiently, and/or the cure speed will be too slow. If the amount is too high, however, all the photoacid generator may not dissolve in the other components of the curable release composition. The amount is often at least 0.25 weight percent, at least 0.3 weight percent, at least 0.5 weight percent, at least 0.7 weight percent, at least 1 weight percent, at least 2 weight percent, at least 3 weight percent, or at least 5 weight percent and up to 10 weight percent, up to 8 weight percent, up to 7 weight percent, up to 5 weight percent, up to 3 weight percent, up to 2 weight percent, or up to 1 weight percent based on the total weight of the curable release composition. The amount can be, for example, in a range of 0.5 to 10 weight percent, 1 to 10 weight percent, 2 to 10 weight percent, 1 to 8 weight percent, or 1 to 5 weight percent based on the total weight of the curable release composition.

Any of the curable release compositions can further include an optional silicate resin. The silicate resin can be added to adjust the adhesion of a release layer to (and the ease of release of the release layer from) an adjoining adhesive layer. Suitable silicate resins typically contain a combination of structural units selected from structural units M (i.e., monovalent R′₃SiO_{1/2} units), structural units D (i.e., divalent R′₂SiO_{2/2} units), structural units T (i.e., trivalent R′SiO_{3/2} units), and structural units Q (i.e., quaternary SiO_{4/2} units) where R′ refers to a hydrocarbyl, which is usually an aryl (e.g., phenyl) or an alkyl (e.g., methyl). Typical exemplary silicate resins include MQ silicate resins, MQD silicate resins, and MQT silicate resins. These silicate resins usually have a number average molecular weight in the range of 100 to 50,000 Daltons, 500 to 15,000 Daltons, or 500 to 10,000 Daltons. Silicate resins can be either nonfunctional or functional silicate resins, the functional resins having one or more reactive groups. Functional groups include, for example, silicon-bonded hydrogen (i.e., silyl hydride groups), silicon-bonded alkenyl (i.e., silyl vinyl groups), and silanol groups. A plurality of silicate resins can be used, if desired.

MQ silicone resins are silicate resins are copolymers having R′₃SiO_{1/2} units (M units) and SiO_{4/2}units (Q units), where R′ is an alkyl or aryl group, and most frequently a methyl group. These resins can also have functional groups. Such resins are described in, for example, Encyclopedia of Polymer Science and Engineering, vol. 15, John Wiley & Sons, N.Y., 1989, pp. 265 to 270 and in various patents such as U.S. Pat. No. 2,676,182 (Daudt et al.), U.S. Pat. No. 3,627,851 (Brady), U.S. Pat. No. 3,772,247 (Flannigan), and U.S. Pat. No. 5,248,739 (Schmidt et al.). MQ silicone resins having functional groups are described in U.S. Pat. No. 4,774,310 (Butler), which describes silyl hydride groups, U.S. Pat. No. 5,262,558 (Kobayashi et al.), which describes vinyl and trifluoropropyl groups, and U.S. Pat. No. 4,707,531 (Shirahata), which describes silyl hydride and vinyl groups. The above-described silicate resins are generally prepared in solvent. Dried or solventless MQ silicate resins are prepared as described in U.S. Pat. No. 5,319,040 (Wengrovius et al.), U.S. Pat. No. 5,302,685 (Tsumura et al.), and U.S. Pat. No. 4,935,484 (Wolfgruber et al.).

MQD silicate resins are terpolymers having R′₃SiO_{1/2}units (M units) and SiO_{4/2} units (Q units) and R′₂SiO_{2/2} units (D units) as described, for example, in U.S. Pat. No. 5,110,890 (Butler). MQT silicate resins are terpolymers having R′₃SiO_{1/2} units (M units), SiO_{4/2} units (Q units), and R′SiO_{3/2} units (T units) such as are described in U.S. Pat. No. 5,110,890 (Butler).

Commercially available silicate resins include resins available under the trade designation SR-545, which is a MQ resin in toluene available from Momentive Inc. (Columbus, Ohio, USA); MQOH resins that are available under the trade designation SQ-299 from Gelest (Morrisville, Pa., USA); MQD resin in toluene that is available from Shin-Etsu Chemical Co. Ltd. (Torrance, Calif., USA) under the trade designations MQR-32-1, MQR-32-2, and MQR-32-3; and a hydride functional MQ resin in toluene that is available under the trade designation PC-403 from Rhone-Poulenc, Latex and Specialty Polymers (Rock Hill, S.C., USA). The silicate resins are often supplied as solutions in an organic solvent. These solutions may be dried, if desired, by any number of techniques known in the art, such as spray drying, oven drying, steam drying, or the like to provide a silicate resin without an organic solvent.

Some release layers do not contain a silicate resin while others do. The silicate resin can be used to adjust the strength of adhesion between the release layer and an adjacent adhesive layer. The amount of the silicate resin is often in a range of 0 to 40 weight percent based on the total weight of the curable release composition. A greater amount of silicate resin tends to increase the force needed to separate the release layer from an adjacent adhesive layer. The amount can be at least 1 weight percent, at least 2 weight percent, at least 3 weight percent, at least 5 weight percent, at least 10 weight percent, at least 15 weight percent and up to 40 weight percent, up to 30 weight percent, up to 25 weight percent, up to 20 weight percent or up to 15 weight percent based on the total weight of the curable release composition.

The curable release composition often contains 20 to 95 weight percent siloxane polymer, 1 to 20 weight percent crosslinker, 1 to 50 weight percent silane additive, 0.25 to 10 weight percent photoacid generator. In some examples, the curable composition contains 40 to 85 weight percent siloxane polymer, 5 to 15 weight percent crosslinker, 10 to 40 weight percent silane additive, and 0.5 to 5 weight percent photoacid generator. In still other examples, the curable composition contains 50 to 80 weight percent siloxane polymer, 5 to 15 weight percent crosslinker, 10 to 30 weight percent silane additive, and 1 to 5 weight percent photoacid generator. In yet other examples, the curable composition contains 40 to 85 weight percent siloxane polymer, 8 to 13 weight percent crosslinker, 12 to 30 weight percent silane additive, and 1 to 3 weight percent photoacid generator. Any of these compositions can include 0 to 40 weight percent or 0 to 20 weight percent silicate resin based on the total weight of the curable release composition.

The curable release composition can be cured by exposure to ultraviolet (UV) or electron beam radiation. In many embodiments, the curable release composition is cured using ultraviolet radiation. The curable release composition is often applied to a major surface of a backing layer prior to curing. Examples of useful UV lights for curing the curable release layer include high intensity UV lights, such as H-type lamps (commercially available from Fusion UV Curing Systems (Gaithersburg, Md., USA)) and medium pressure mercury lamps. When organic solvents are included in the curable release composition, treatment in a thermal oven may be needed prior to remove the organic solvents prior to curing with UV radiation. The cured release layer is attached to the backing layer and it not easily separated from the backing layer.

In a second aspect, an article is provided that includes a) a backing layer having a first major surface and a second major surface opposite the first major surface and b) a first release layer adjacent to the first major surface of the backing layer. The first release layer comprises a first cured reaction product of a first curable release composition that contains i) a first siloxane polymer having a weight average molecular weight of at least 1000 Daltons, ii) a first crosslinker, iii) a first silane additive, iv) a first photoacid generator, and v) an optional first silicate resin. The first siloxane polymer is of Formula (I).

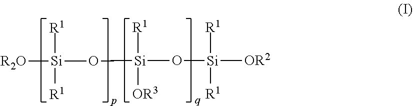

In Formula (I), R¹ is alkyl, R² is hydrogen or alkyl, and R³ is alkyl. Variable p is an integer equal to at least 10 and variable q is an integer in a range of 0 to 0.1(p). The first crosslinker is a compound of formula Si(OR⁵)₄ or is a compound having at least two silyl groups of formula —Si(R⁴)ₓ(OR⁵)₃₋ₓ where R⁴ is alkyl or aryl, R⁵ is alkyl, and the variable x is an integer equal to 0 or 1. The first silane additive has two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl.

Any suitable backing can be used. In some applications, the backing layer can be constructed of paper, polymeric material, metal, or a combination thereof. The backing layer is usually flexible and is suitable for winding into a roll. The backing can include multiple layers of different materials. In many embodiments the backing includes a polymeric film that is prepared from polyester (e.g., polyethylene terephthalate, polybutylene terephthalate, polycaprolactone, and polylactic acid), polyolefin (e.g., polyethylene, polypropylene (e.g., isotactic polypropylene)), polystyrene, polyvinylidene fluoride, polyvinyl alcohol, polyvinyl acetate, ethyl cellulose, cellulose acetate, or copolymers thereof. The thermoplastic films can contain oriented polymeric material in one or two directions such as, for example, biaxially oriented polypropylene. Each major surface of the backing layer can be treated, if desired, to enhance chemical and/or physical anchorage of the release layer(s) to the backing layer by application of primer, corona treatment, flame treatment, ozone treatment, or the like. That is, the release layer is attached (e.g., permanently attached or adhered) to the backing layer and is not easily removed or separated from the backing layer.

The first siloxane polymer is the same as the siloxane polymer described above for the curable release composition. Likewise, the first crosslinker, the first silane additive, the first photoacid generator, and the first silicate resin are the same as the crosslinker, silane additive, photoacid generator, and silicate resin described above for the curable release composition.

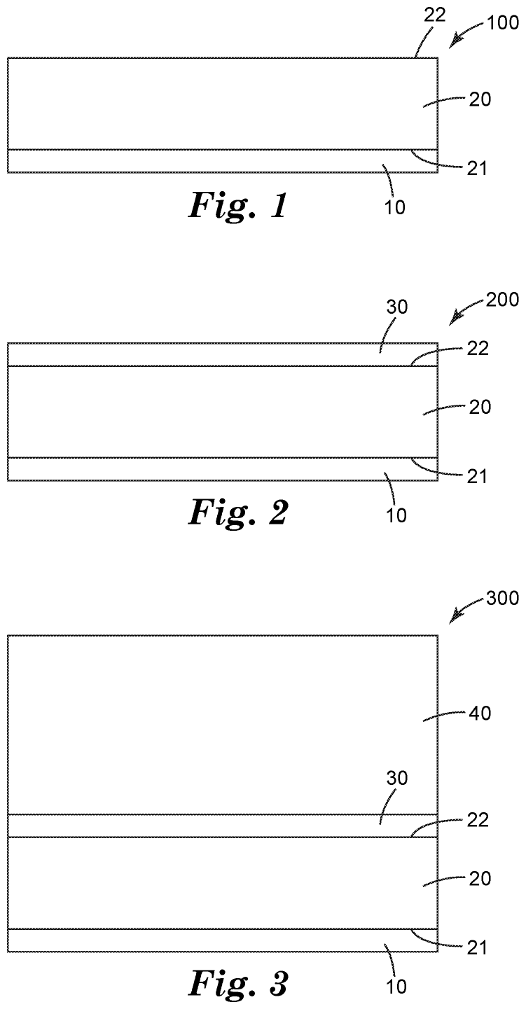

The article or a portion of the article can be as shown in FIG. 1 where the backing layer 20 has a first major surface 21 and a second major surface 22 opposite the first major surface 21. A release layer 10 is positioned adjacent to the first major surface 21 of the backing layer 20 in article 100.

In some embodiments of the article, there is a second release layer positioned adjacent to the second major surface of the backing layer as shown in FIG. 2. Article 200 is arranged in the following order: second release layer 30-backing layer 20-first release layer 10. Such as article can be used as a release liner in a transfer adhesive tape.

The second release layer can be of a similar composition to the first release layer but typically contains more of the silicate resin. More specifically, the second release layer comprises a second cured reaction product of a second curable release composition comprising i) a second siloxane polymer of Formula (I) having a weight average molecular weight of at least 1000 Daltons, ii) a second crosslinker that is a compound of formula Si(OR⁵)₄ or is a compound having at least two silyl groups of formula —Si(R⁴)ₓ(OR⁵)₃₋ₓ, iii) a second silane additive having two silyl groups of formula —Si(R⁶)₂(OR⁷) or having a single silyl group of formula —Si(R¹⁰)(OR⁹)₂, iv) a second photoacid generator, and v) a second silicate resin. The second siloxane polymer, the second crosslinker, the second silane additive, the second photoacid generator, and the second silicate resin are the same as described above for the release layer composition. The amounts of each of these components is also the same as described above for the release layer composition with the exception that the second release layer composition typically includes the silicate resin.

The amount of the second silicate resin in the second release layer is typically greater than the amount of the first silicate resin in the first release layer. The difference can be at least 1 weight percent, at least 2 weight percent, at least 5 weight percent, at least 10 weight percent, at least 15 weight percent, or at least 20 weight percent and up to 40 weight percent, up to 30 weight percent, or up to 20 weight percent. In some embodiments, the first release layer is free of the first silicate resin (i.e., the amount of the optional first silicate resin is 0 weight percent or less than 1 weight percent) while the second release layer contains the second silicate resin. In these embodiments, the amount of the second silicate resin is often greater than 1 weight percent, at least 2 weight percent, at least 5 weight percent, at least 10 weight percent, or at least 15 weight percent.

When used as a release liner, an adhesive layer can be positioned adjacent to the second release layer to form an adhesive transfer tape. Such an article 300 (i.e., adhesive transfer tape) is shown in FIG. 3. Article 300 is arranged in the following order: adhesive layer 40-second release layer 30-backing layer 20-first release layer 10. First release layer 10 is positioned adjacent to the first major surface 21 of the backing layer 20 and the second release layer 30 is positioned adjacent to the second major surface 22 of the backing layer 20. The adhesive layer 40 is positioned adjacent to the second release layer 30 opposite the backing layer 20. The second release layer 30 is more strongly attached to backing layer 20 than to adhesive layer 40. If desired, the adhesive layer 40 can be released from (i.e., separated from) the release layer 30. This release occurs such that release layer 30 remains attached to backing layer 20. That is, the release layer is more strongly attached to the backing layer 20 than to the adhesive layer 40.

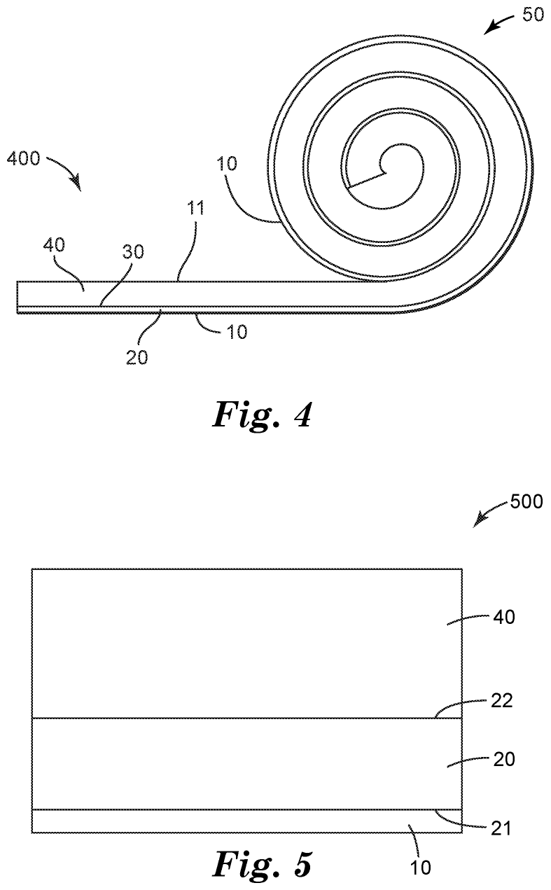

When the article 300 is rolled to form a roll of adhesive transfer tape, the adhesive layer 40 is adjacent to both the second release layer 30 and the first release layer 10. This can be seen in rolled article 400 of FIG. 4. The roll 50 has the first release layer 10 on the outermost surface. The surface 11 of the adhesive layer 40 contact the first release layer 10 in the roll 50. To unroll the adhesive transfer tape for use, it is desirable that the strength of adhesion of the adhesive layer 40 to the first release layer 10 is less than to the second release layer 30. This can be accomplished by having a greater amount of the silicate resin in the second release layer 30 than in the first release layer 10. After being unrolled, the adhesive layer 40 can be released from the second release layer 30 and applied to another substrate. The release layers 10 and 30 are more strongly attached to the backing layer 20 than to the adhesive layer 40.

In other embodiments, the article can be as shown in FIG. 5. This article 500 includes a first release layer 10, a backing layer 20 with a first major surface 21 adjacent to the backing layer, and an adhesive layer 40 positioned adjacent to a second major surface 22 of the backing layer opposite the first major surface 21. The overall construction is in the following order: first release layer 10-backing layer 20-adhesive layer 40. The adhesive layer 40 is strongly attached (i.e., adhered to the backing layer). If rolled, adhesive layer 40 contacts release layer 10 in the roll (not shown). The release layer 10 is attached more strongly to the backing layer 20 than to the adhesive layer 40. The release layer 10 can be released from the adhesive layer 40 but not the backing layer 20 when the article is unrolled. If desired, other optional layers not shown in FIG. 5 can be included. For example, there can be a primer layer between the backing layer 20 and the adhesive layer 40.

Any suitable adhesive layer 40 can be used. The adhesive can be in the form of a film or foam. In some embodiments, the adhesive layer 40 is a single layer. In other embodiments, the adhesive layer 40 is one layer of a multilayer adhesive construction such as a double sided adhesive tape. For example, the multilayer adhesive tape can have a first adhesive skin layer, a second adhesive skin layer, and a core layer positioned between the first adhesive skin layer and the second adhesive skin layer. The core layer is often a foam backing layer and can be an adhesive or non-adhesive foam. In another example, the multilayer adhesive tape can have a first adhesive layer, a film backing, and a second adhesive layer. The film backing can be an adhesive or non-adhesive layer.

One class of adhesives that can be included in the adhesive layer 40 are pressure-sensitive adhesives that are based on (meth)acrylate copolymers. The (meth)acrylate copolymers typically have a glass transition temperature (Tg) that is no greater than 20° C., no greater than 10° C., no greater than 0° C., no greater than −10° C., no greater than −20° C., no greater than −30° C., no greater than −40° C., or no greater than −50° C. The glass transition temperature can be measured using techniques such as Differential Scanning Calorimetry and Dynamic Mechanical Analysis. Alternatively, the glass transition temperature can be estimated using the Fox equation based on the monomers used to form the adhesive. Lists of glass transition temperatures for homopolymers are available from multiple monomer suppliers such as from BASF Corporation (Houston, Tex., USA), Polyscience, Inc. (Warrington, Pa., USA), and Aldrich (St. Louis, Mo., USA) as well as in various publications such as, for example, Mattioni et al., J. Chem. Inf. Comput. Sci., 2002, 42, 232-240.

The (meth)acrylate copolymers typically are formed from a monomer composition that contains at least one low Tg monomer. As used herein, the term “low Tg monomer” refers to a monomer having a Tg no greater than 20° C. when homopolymerized (i.e., a homopolymer formed from the low Tg monomer has a Tg no greater than 20° C.). Suitable low Tg monomers are often selected from an alkyl (meth)acrylates, heteroalkyl (meth)acrylates, aryl substituted alkyl acrylate, and aryloxy substituted alkyl acrylates.

Example low Tg alkyl (meth)acrylate monomers often are non-tertiary alkyl acrylates but can be alkyl methacrylates having a linear alkyl group with at least 4 carbon atoms. Specific examples of alkyl (meth)acrylates include, but are not limited to, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, and n-dodecyl methacrylate. Isomers and mixture of isomers of these monomers can be used.

Example low Tg heteroalkyl (meth)acrylate monomers often have at least 3 carbon atoms, at least 4 carbon atoms, or at least 6 carbon atoms and can have up to 30 or more carbon atoms, up to 20 carbon atoms, up to 18 carbon atoms, up to 16 carbon atoms, up to 12 carbon atoms, or up to 10 carbon atoms. Specific examples of heteroalkyl (meth)acrylates include, but are not limited to, 2-ethoxyethyl acrylate, 2-(2-ethoxyethoxy)ethyl acrylate, 2-methoxyethyl (meth)acrylate, and tetrahydrofurfuryl (meth)acrylate.

Exemplary low Tg aryl substituted alkyl acrylates or aryloxy substituted alkyl acrylates include, but are not limited to, 2-biphenylhexyl acrylate, benzyl acrylate, 2-phenoxyethyl acrylate, and 2-phenylethyl acrylate.

Some monomer compositions can include an optional polar monomer. The polar monomer has an ethylenically unsaturated group plus a polar group such as an acidic group or a salt thereof, a hydroxyl group, a primary amido group, a secondary amido group, a tertiary amido group, or an amino group. Having a polar monomer often facilitates adherence of the pressure-sensitive adhesive to a variety of substrates.

Exemplary polar monomers with an acidic group include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinyl phosphonic acid, and mixtures thereof. Due to their availability, the acid monomers are often (meth)acrylic acids.

Exemplary polar monomers with a hydroxyl group include, but are not limited to, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, Pa., USA) under the trade designation CD570, CD571, and CD572), and aryloxy substituted hydroxyalkyl (meth)acrylates (e.g., 2-hydroxy-2-phenoxypropyl (meth)acrylate).

Exemplary polar monomers with a primary amido group include (meth)acrylamide. Exemplary polar monomers with secondary amido groups include, but are not limited to, N-alkyl (meth)acrylamides such as N-methyl (meth)acrylamide, N-ethyl (meth)acrylamide, N-isopropyl (meth)acrylamide, N-tert-octyl (meth)acrylamide, or N-octyl (meth)acrylamide.

Exemplary polar monomers with a tertiary amido group include, but are not limited to, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include, but are not limited to, N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

The monomer composition can optionally include a high Tg monomer. As used herein, the term “high Tg monomer” refers to a monomer that has a Tg greater than 30° C., greater than 40° C., or greater than 50° C. when homopolymerized (i.e., a homopolymer formed from the monomer has a Tg greater than 30° C., greater than 40° C., or greater than 50° C.). Some suitable high T_{g} monomers have a single (meth)acryloyl group such as, for example, methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, 2-phenoxyethyl methacrylate, N-octyl (meth)acrylamide, and mixtures thereof. Other suitable high Tg monomers have a single vinyl group that is not a (meth)acryloyl group such as, for example, various vinyl ethers (e.g., vinyl methyl ether), vinyl esters (e.g., vinyl acetate and vinyl propionate), styrene, substituted styrene (e.g., a-methyl styrene), vinyl halide, and mixtures thereof. Vinyl monomers having a group characteristic of polar monomers are considered herein to be polar monomers.

Still further, the monomer composition can optionally include a vinyl monomer (i.e., a monomer with an ethylenically unsaturated group that is not a (meth)acryloyl group). Examples of optional vinyl monomers include, but are not limited to, various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. The vinyl monomers having a group characteristic of polar monomers are considered herein to be polar monomers.

Overall the pressure-sensitive adhesive can contain up to 100 weight percent (e.g., 100 weight percent) low Tg monomer units. The weight percent value is based on the total weight of monomeric units in the polymeric material. In some embodiments, the polymeric material contains 40 to 100 weight percent of the low Tg monomeric units, 0 to 15 weight percent polar monomeric units, 0 to 50 weight percent high Tg monomeric units, and 0 to 15 weight percent vinyl monomeric units. In still other embodiments, the polymer contains 60 to 100 weight percent of the low Tg monomeric units, 0 to 10 weight percent polar monomeric units, 0 to 40 weight percent high Tg monomeric units, and 0 to 10 weight percent vinyl monomeric units. In yet other embodiments, the polymer contains 75 to 100 weight percent of the low Tg monomeric units, 0 to 10 weight percent polar monomeric units, 0 to 25 weight percent high Tg monomeric units, and 0 to 5 weight percent vinyl monomeric units.

A second class of polymers useful in the adhesive layer 40 includes: semi-crystalline polymer resins, such as polyolefins and polyolefin copolymers (e.g., polymer resins based upon monomers having between 2 and 8 carbon atoms, such as low-density polyethylene, high-density polyethylene, polypropylene, and ethylene-propylene copolymers); polyesters and co-polyesters; polyamides and co-polyamides; fluorinated homopolymers and copolymers; polyalkylene oxides (e.g., polyethylene oxide and polypropylene oxide); polyvinyl alcohol; ionomers (e.g., ethylene-methacrylic acid copolymers neutralized with a base); and cellulose acetate. Other examples of polymers in this class include amorphous polymers such as polyacrylonitrile polyvinyl chloride, thermoplastic polyurethanes, aromatic epoxies, polycarbonates, amorphous polyesters, amorphous polyamides, ABS block copolymers, polyphenylene oxide alloys, ionomers (e.g., ethylene-methacrylic acid copolymers neutralized with salt), fluorinated elastomers, and polydimethyl siloxane.

A third class of polymers useful in the adhesive layer 40 includes elastomers such as polybutadiene, polyisoprene, polychloroprene, random and block copolymers of styrene and dienes (e.g., SBR), and ethylene-propylene-diene monomer rubber. This class of polymer is typically combined with tackifying resins.

In some embodiments, the adhesives of this class are like those described, for example, in U.S. Pat. No. 9,556,367 (Waid et al.). The adhesive is a pressure-sensitive adhesive and contains 92 to 99.9 parts of a block copolymer adhesive composition and 0.1 to less than 10 parts of an acrylic adhesive composition. The block copolymer adhesive composition comprises a first block copolymer comprising i) at least one rubbery block comprising a first polymerized conjugated diene, a hydrogenated derivative thereof, or combinations thereof and ii) at least one glassy block comprising a first polymerized mono-vinyl aromatic monomer. The acrylic adhesive composition comprises 70 to 100 parts of at least one acrylic or methacrylic ester of a non-tertiary alkyl alcohol, wherein the non-tertiary alkyl alcohol contains 4 to 20 carbon atoms; and 0 to 30 parts of a copolymerized reinforcing monomer.

In some embodiments, the first block copolymer is a multi-arm block copolymer of the formula Qₙ-Y, wherein Q represents an arm of the multi-arm block copolymer, n represents the number of arms and is a whole number of at least 3, and Y is the residue of a multifunctional coupling agent. Each arm, Q, independently has the formula R-G where R represents the rubbery block and G represents the glassy block. In some embodiments, the first block copolymer is a polymodal, asymmetric star block copolymer.

In some embodiments, the pressure sensitive adhesive further comprises a second block copolymer. The second block copolymer contains at least one rubbery block and at least one glassy block. The rubbery block comprises a polymerized second conjugated diene, a hydrogenated derivative thereof, or combinations thereof and the glassy block comprises a second polymerized mono-vinyl aromatic monomer. In some embodiments, the second block copolymer is a linear block copolymer.

The pressure sensitive adhesive further comprises a first high Tg tackifier having a Tg of at least 60° C., wherein the first high Tg tackifier is compatible with at least one rubbery block. In some embodiments, the block copolymer adhesive composition further comprises a second high Tg tackifier having a Tg of at least 60° C., wherein the second high Tg tackifier is compatible with the at least one glassy block.

A fourth class of polymers useful in the adhesive layer 40 includes pressure-sensitive and hot melt applied adhesives prepared from non-photopolymerizable monomers. Such polymers can be adhesive polymers (i.e., polymers that are inherently adhesive), or polymers that are not inherently adhesive but can form adhesive compositions when compounded with components such as plasticizers and/or tackifiers. Specific examples include poly-alpha-olefins (e.g., polyoctene, polyhexene, and atactic polypropylene), block copolymer-based adhesives, natural and synthetic rubbers, silicone adhesives, ethylene-vinyl acetate, and epoxy-containing structural adhesive blends (e.g., epoxy-acrylate and epoxy-polyester blends).

The adhesive layer 40 may optionally contain other components such as, for example, fillers, antioxidants, viscosity modifiers, pigments, tackifying resins, fibers, and the like. These components can be added to the adhesive layer 40 to the extent that they do not alter the desired properties of the final product.

A preferred optional component is a pigment. Any compound generally used as a pigment can be utilized provided the desired properties of the final product are not negatively impacted. Exemplary pigments include carbon black and titanium dioxide. The amount of pigment also depends on the desired use of the product. Generally, the pigment concentration is at least 0.10 weight percent based on the total weight of the adhesive. The amount can be at least 0.15 weight percent or greater than 0.2 weight percent, at least 0.5 weight percent, or at least 1 weight percent and up to 10 weight percent or higher, up to 5 weight percent, up to 2 weight percent, or up to 1 weight percent based on the total weight of the adhesive. The pigment can give an opaque appearance to the adhesive layer.

The adhesive layer 40, if desired, can be at least partially crosslinked by electron beam (“E-beam”) radiation, although additional crosslinking means (e.g., chemical, heat, gamma radiation, and/or ultraviolet and/or visible radiation) may also be used. Crosslinking can impart more desirable characteristics (e.g., increased strength) to the adhesive layer. Electron beam radiation is advantageous because it can crosslink (i.e., cure) adhesive layers that contain pigments or filler and adhesive layers that are relatively thick.

E-Beam radiation causes crosslinking of the adhesive layer by initiating a free-radical chain reaction. Ionizing particulate radiation from the E-Beam is absorbed directly in the polymer and generates free radicals that initiate the crosslinking process. Generally, electron energies of at least about 100 kiloelectron volts (keV) are necessary to break chemical bonds and ionize, or excite, components of the polymer system. The scattered electrons that are produced lead to a large population of free radicals dispersed throughout the adhesive. These free radicals initiate crosslinking reactions (e.g., free-radical polymerization, radical-radical coupling), which results in a three-dimensionally crosslinked polymer.

An electron beam processing unit supplies the radiation for this process. Generally, a processing unit includes a power supply and an E-Beam acceleration tube. The power supply increases and rectifies the current, and the accelerator generates and focuses the E-Beam and controls the scanning. The electron beam may be produced, for example, by energizing a tungsten filament with high voltage. This causes electrons to be produced at high rates. These electrons are then concentrated to form a high energy beam and are accelerated to full velocity inside the electron gun. Electromagnets on the sides of the accelerator tube allow deflection, or scanning, of the beam.

Scanning widths and depths typically vary from about 61 to 183 centimeters (cm) to about 10 to 15 cm, respectively. The scanner opening is covered with a thin metal foil, usually titanium, which allows passage of electrons, but maintains a high vacuum in the processing chamber. Characteristic power, current, and dose rates of accelerators are about 200 to 500 keV, about 25 to 200 milliamps (mA), and about 1 to 10 megarads (Mrads), respectively. To minimize peroxide formation, the process chamber should be kept at as low an oxygen content as is practical, for example, by nitrogen purging, although this is not a requirement.

Advantageously, the adhesive layer can be crosslinked with electron beam radiation while adjacent to a release layer with minimal or no impact on the ability to separate the release layer from the adhesive layer. This contrasts with many known release layers. Adhesive layer 40 in FIG. 3 can be crosslinked while in contact with release layer 30. The electron beam radiation does not significantly alter the ability to remove the adhesive layer 40 from release layer 30 for use as a transfer adhesive. Adhesive layer 40 in FIG. 3 and in FIG. 5 can be crosslinked without negatively impacting the release characteristics of release layer 10. That is, rolls formed from article 300 in FIG. 3 or from article 500 in FIG. 5 can be unrolled readily even after exposure of the release layer 10 to electron beam radiation.

In another aspect, a method of making an article is provided. The method includes providing a backing having a first major surface and a second major surface opposite the first major surface. The method further includes applying a first curable release composition adjacent to the first major surface of the backing. The first curable release composition is the same as described above. The method still further includes exposing the first curable release composition to ultraviolet radiation or electron beam radiation to form a first release layer.

In some embodiments of the method, a curable adhesive layer is positioned adjacent to the second major surface of the backing layer. A cured adhesive layer is formed by exposing the curable adhesive layer to electron beam radiation with the electron beam radiation passing through the first release layer and the backing prior to reaching the curable adhesive layer.

In other embodiments of the method, after forming the first release layer on the first major surface of the backing, a second curable release composition is positioned adjacent to the second major surface of the backing. The second curable release composition contains i) a second siloxane polymer of Formula (I) having a weight average molecular weight of at least 1000 Daltons, ii) a second crosslinker is a compound of formula Si(OR⁵)₄ or is a compound having at least two silyl groups of formula —Si(R⁴)ₓ(OR⁵)₃₋ₓ, iii) a second silane additive having two silyl groups of formula —Si(R⁶)₂(OR⁷) or having a single silyl group of formula —Si(R¹⁰)(OR⁹)₂, iv) a second photoacid generator, and v) a second silicate resin. The second curable release composition is the same as described above and contains more silicate resin than the first curable release composition. The method still further includes exposing the second curable release composition to ultraviolet radiation or electron beam radiation to form a second release layer.

In still other embodiments of the method where there are two release layers, a curable adhesive layer is positioned adjacent to the second release layer opposite the backing layer. The method can further include forming a cured adhesive layer by exposing the curable adhesive layer to electron beam radiation with the electron beam radiation passing through the first release layer, the backing, and the second release layer prior to reaching the curable adhesive layer.

Advantageously, the release characteristics of the first release layer and/or the second release layer towards the cured adhesive layer is not altered significantly be exposure of the release layer(s) to electron beam radiation.

Embodiment 1A is a release layer that comprises a first cured reaction product of a curable release composition that contains i) a siloxane polymer having a weight average molecular weight of at least 1000 Daltons, ii) a crosslinker, iii) a silane additive, iv) a photoacid generator, and v) an optional silicate resin. The siloxane polymer is of Formula (I).

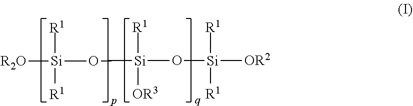

In Formula (I), R¹ is alkyl, R² is hydrogen or alkyl, and R³ is alkyl. Variable p is an integer equal to at least 10 and variable q is an integer in a range of 0 to 0.1(p). The first crosslinker is a compound of formula Si(OR⁵)₄ or is a compound having at least two silyl groups of formula —Si(R⁴)ₓ(OR⁵)₃₋ₓ where R⁴ is alkyl or aryl, R⁵ is alkyl, and the variable x is an integer equal to 0 or 1. The first silane additive is a compound having two silyl groups of formula —Si(R⁶)₂(OR⁷) or a single silyl group of formula —Si(R¹⁰)(OR⁹)₂ where R⁶ is alkyl or aryl, R⁷ is alkyl, R⁹ is alkyl, and R¹⁰ is alkyl or aryl.

Embodiment 2A is the release layer of Embodiment 1A, wherein the siloxane polymer of Formula (I) has a weight average molecular weight in a range of 1000 to 500,000 Daltons.

Embodiment 3A is the release layer of Embodiment 1A or 2A, wherein the siloxane polymer has a weight average molecular weight in a range of 1000 to 50,000 Daltons.

Embodiment 4A is the release layer of any one of Embodiments 1A to 3A, wherein the variable p is in a range of 10 to 1000 and q is in a range from 0 to 100.

Embodiment 5A is the release layer of any one of Embodiments 1A to 4A, wherein the curable release composition contains 20 to 95 weight percent or 40 to 85 weight percent of the silane polymer of Formula (I) based on the total weight of the curable release composition.

Embodiment 6A is the release layer of any one of Embodiments 1A to 5A, wherein the crosslinker is of Formula (II).

(OR⁵)₃₋ₓ(R⁴)ₓSi—R⁸—Si(R⁴)ₓ(OR⁵)₃₋ₓ (II)

In Formula (II), R⁸ is oxy, a group of formula —O—[Si(CH₃)₂—O]ₘ—, an alkylene, a heteroalkylene, a heteroarylene substituted with a hydroxyl group, an arylene, a fluorine substituted arylene, or an alkylene-arylene-alkylene group. The variable m is an integer in a range of 1 to 10. Groups R⁴ is alkyl or aryl and R⁵ is alkyl.

Embodiment 7A is the release layer of any one of Embodiments 1A to 5A, wherein the crosslinker is a compound of formula Si(OR⁵)₄ where R⁵ is alkyl.

Embodiment 8A is the release layer of any one of Embodiments 1A to 7A, wherein the curable release composition contains 1 to 20 weight percent or 5 to 15 weight percent crosslinker based on the total weight of the curable release composition.

Embodiment 9A is the release layer of any one of Embodiments 1A to 8A, wherein the silane additive is of Formula (III).

(R⁷O)(R⁶)₂Si—R¹¹—Si(R⁶)₂(OR⁷) (III)

In Formula (III), R¹¹ is oxy, a group of formula —O—[Si(CH₃)₂—O]ₙ—, alkylene, arylene, fluorinated arylene, or alkylene-arylene-alkylene group. The variable n is an integer in a range of 1 to 10.

Embodiment 10A is the release layer of any one of Embodiments 1A to 8A, wherein the silane additive is of Formula (IV).

R¹²—Si(R¹⁰)(OR⁹)₂ (IV)

In Formula (IV), R⁹ is alkyl and R¹⁰ is alkyl or aryl. Group R¹² is alkyl, aryl, or a group of formula —R¹³—Si(R¹⁴)₃ where R¹³ is alkylene and each R¹⁴ is independently alkyl.

Embodiment 11A is the release layer of any one of Embodiments 1A to 10A, wherein the curable release composition contains 1 to 50 weight percent or 10 to 40 weight percent silane additive based on the total weight of the curable release composition.

Embodiment 12A is the release layer of any one of Embodiments 1A to 11A, wherein the photoacid generator is a diaryliodonium salt or a triarylsulfonium salt, wherein any aryl group is optionally substituted with an alkyl group.

Embodiment 13A is the release layer of Embodiment 12A, wherein the anion of the diaryliodonium salt of the triarylsulfonium salt is selected from PF₆⁻, SbF₆⁻, SbF₅OH⁻, Ph₄B⁻, and (PhF₅)₄B⁻ where Ph refers to phenyl.

Embodiment 14A is the release layer of any one of Embodiments 1A to 13A, wherein the curable release composition contains 0.25 to 10 weight percent or 0.5 to 5 weight percent photoacid generator based on the total weight of the curable release composition.

Embodiment 15A is the release layer of any one of Embodiments 1A to 14A, wherein the curable release composition contains a silicate resin that is an MQ silicate resin, MQD silicate resin, MDT silicate resin, or a mixture thereof.

Embodiment 16A is the release layer of any one of Embodiments 1A to 15A, wherein the curable release composition contains 0 to 40 weight percent or 0 to 20 weight percent silicate resin based on the total weight of the curable release composition.

Embodiment 17A is the release layer of any one of Embodiments 1A to 16A, wherein the curable release composition contains 20 to 95 weight percent siloxane polymer, 1 to 20 weight percent crosslinker, 1 to 50 weight percent silane additive, 0.25 to 10 weight percent photoacid generator, and 0 to 40 weight percent silicate resin.

Embodiment 18A is the release layer of any one of Embodiments 1A to 17A, wherein the curable release composition contains 40 to 85 weight percent siloxane polymer, 5 to 15 weight percent crosslinker, 10 to 40 weight percent silane additive, 0.5 to 5 weight percent photoacid generator, and 0 to 40 weight percent silicate resin.

Embodiment 19A is the release layer of any one of Embodiments 1A to 18A, wherein the curable release composition contains 50 to 80 weight percent siloxane polymer, 5 to 15 weight percent crosslinker, 10 to 30 weight percent silane additive, and 1 to 5 weight percent photoacid generator, and 0 to 40 weight percent silicate resin.

Embodiment 20A is the release layer of any one of Embodiments 1A to 19A, wherein the curable composition is cured by exposure to ultraviolet radiation or electron beam radiation.

Embodiment 1B is an article that includes a) a backing layer having a first major surface and a second major surface opposite the first major surface and b) a first release layer adjacent to the first major surface of the backing layer. The first release layer comprises a first cured reaction product of a first curable release composition that contains i) a first siloxane polymer having a weight average molecular weight of at least 1000 Daltons, ii) a first crosslinker, iii) a first silane additive, iv) a first photoacid generator, and v) an optional first silicate resin. The first siloxane polymer is of Formula (I).

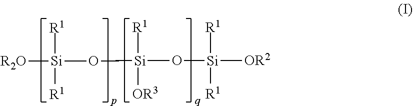

In Formula (I), R¹ is alkyl, R² is hydrogen or an alkyl, and R³ is alkyl. Variable p is an integer equal to at least 10 and variable q is an integer in a range of 0 to 0.1(p). The first crosslinker is a compound of formula Si(OR⁵)₄ or is a compound having at least two silyl groups of formula —Si(R⁴)ₓ(OR⁵)₃₋ₓ where R⁴ is alkyl or aryl, R⁵ is alkyl, and the variable x is an integer equal to 0 or 1. The first silane additive is a compound having two silyl groups of formula —Si(R⁶)₂(OR⁷) or a single silyl group of formula —Si(R¹⁰)(OR⁹)₂ where R⁶ is an alkyl or aryl, R⁷ is an alkyl, R⁹ is alkyl, and R¹⁰ is alkyl or aryl.

Embodiment 2B is the article of Embodiment 1B, further comprising an adhesive layer adjacent to the second major surface of the backing layer.

Embodiment 3B is the article of Embodiment 1B, further comprising a second release layer adjacent to the second major surface of the backing layer wherein the second release layer comprises a second cured reaction product of a second curable release composition. The second curable release composition comprises i) a second siloxane polymer of Formula (I), ii) a second crosslinker that is a compound of formula Si(OR⁵)₄ or is a compound having at least two silyl groups of formula —Si(R⁴)ₓ(OR⁵)₃₋ₓ, iii) a second silane additive having two silyl groups of formula —Si(R⁶)₂(OR⁷) or having a single silyl group of formula —Si(R¹⁰)(OR⁹)₂, iv) a second photoacid generator, and v) a second silicate resin, wherein the amount of the second silicate resin in the second release layer is greater than the amount of the first silicate resin in the first release layer.

Embodiment 4B is the article of Embodiment 3B, further comprising a first adhesive layer adjacent to the second release layer opposite the backing layer.

Embodiment 5B is the article of Embodiment 4B, wherein the adhesive layer is a first adhesive skin layer of a multilayer adhesive comprising the first adhesive skin layer, a core layer, and a second adhesive skin layer with the core layer positioned between the first adhesive skin layer and the second adhesive skin layer.

Embodiment 6B is the article of Embodiment 5B, wherein the core of the multilayer adhesive is a foam.

Embodiment 7B is the article of any one of Embodiments 1B to 6B, wherein the first release composition is according to any one of Embodiments 2A to 20A.

Embodiment 8B is the article of any one of Embodiments 3B to 7B, wherein the second release composition is according to any one of Embodiments 2A to 20A.

Embodiment 1C is a method of making an article is provided. The method includes providing a backing having a first major surface and second major surface opposite the first major surface. The method further includes applying a first curable release composition adjacent to the first major surface of the backing. The first curable release composition is the same as described above in the second aspect. The method still further includes exposing the first curable release composition to ultraviolet radiation or electron beam radiation to form a first release layer.

Embodiment 2C is the method of Embodiment 1C, further comprising positioning a curable adhesive layer adjacent to the second major surface of the backing layer.

Embodiment 3C is the method of Embodiment 2C, further comprising forming a cured adhesive layer by exposing the curable adhesive layer to electron beam radiation with the electron beam radiation passing through the first release layer and the backing prior to reaching the curable adhesive layer.

Embodiment 4C is the method of Embodiment 1C, further comprising applying a second curable release composition adjacent to the second major surface of the backing, wherein the second curable release composition comprises i) a second siloxane polymer of Formula (I), ii) a second crosslinker is a compound of formula Si(OR⁵)₄ or is a compound having at least two silyl groups of formula —Si(R⁴)ₓ(OR⁵)₃₋ₓ, iii) a second silane additive having two silyl groups of formula —Si(R⁶)₂(OR⁷) or having a single silyl group of formula —Si(R¹⁰)(OR⁹)₂, iv) a second photoacid generator, and v) a second silicate resin.

Embodiment 5C is the method of Embodiment 4C, further comprising positioning a curable adhesive layer adjacent to the second release layer opposite the backing layer.

Embodiment 6C is the method of Embodiment 5C, further comprising forming a cured adhesive layer by exposing the curable adhesive layer to electron beam radiation with the electron beam radiation passing through the first release layer, the backing, and the second release layer prior to reaching the curable adhesive layer.

Embodiment 7C is the method of Embodiments 1C or 2C, wherein the first release composition is according to any one of Embodiments 2A to 20A.

Embodiment 8C is the method of any one of Embodiments 4C to 6C, wherein the second release composition is according to any one of Embodiments 2A to 20A.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1 (below) lists materials used in the examples and their sources.

TABLE 1
Materials List

| Material | Description and Source |
|---|---|
| 1,3-Tetramethyldisiloxane | Reactant used to prepare a silane additive; available from Gelest, |
| | Incorporated (Morrisville, PA, USA) |
| 1,2-Bis(dimethylsilyl)ethane | Reactant used to prepare a silane additive; available from Gelest, |
| | Incorporated (Morrisville, PA, USA) |
| Vinylmethyldiethoxysilane | Reactant used to prepare a silane additive; available from Gelest, |
| | Incorporated (Morrisville, PA, USA) |
| Anhydrous Ethanol | Available under the trade designation KOPTEC Ethanol-200 |
| | Proof from Decon Laboratories, Inc. (King of Prussia, PA, USA) |
| Methanol | Organic solvent available from Sigma Aldrich Corporation (St. |
| | Louis, MO, USA) |
| DMS-S12 Y01 | Trade designation for a siloxane polymer that is a silanol |
| | terminated polydimethylsiloxane with molecular weight of about |
| | 700 grams/mole; available from Gelest, Incorporated (Morrisville, |
| | PA, USA) |
| XIAMETER PMX-0930 | Trade designation for a siloxane polymer that is a silanol |
| (referred to as PMX-0930) | terminated polydimethylsiloxane with a molecular weight of about |
| | 2400 g/mole; available under the trade designation XIAMETER |
| | PMX-0930 from Dow Corning Corporation (Midland, MI, USA) |
| Karstedt's Catalyst | a platinum-divinyltetramethyldisiloxane complex in xylene, |
| | containing between 2.1 and 2.4 weight percent (wt-%) platinum |
| | concentration (concentration of pure platinum metal); available |
| | from Gelest (Morrisville, PA, USA) |
| 1,8- | Crosslinker that is available from Gelest, Incorporated |
| bis(triethoxvsilyl)octane | (Morrisville, PA, USA) |
| (XL-1) | |
| SQO-299 | Trade designation for a silanol-trimethylsilyl modified Q resin, |
| | which can be referred to as MQ resin or trimethylsiloxysilicate; |
| | available under the trade designation from Gelest (Morrisville, |
| | PA. USA) |
| Triethylsilane | Reactant used to prepare a silane additive that is 95-100% pure, |
| | has a boiling point of 107° C., and has a molecular weight of 116 |
| | grams/mole; available from Gelest, Incorporated, Morrisville, PA, |
| | USA) |
| XG-2509 | Mixture of MQ resin and siloxane polymer that was prepared bv |
| | mixing 35 wt-% of SQO-299 and 65 wt-% of DMS-S12 Y01 |
| Bis(dodecylphenyl)iodonium | Photo acid generator (PAG) available from various suppliers |
| hexafluoroantimonate | (CAS No. 71786-70-4) |
| 3SAB PET | 2-mil (50.8 micrometers) thick polyester terephthalate (PET) film, |
| | commercially available under the trade designation |
| | “HOSTAPHAN 3SAB” from Mitsubishi Polyester Film (Greer, |
| | SC, USA) |
| Palladium Catalyst I | 5.0 wt-% palladium loading on activated charcoal (used to prepare |
| | a silane additive); available from Sigma Aldrich Corporation (St. |
| | Louis, MO, USA) |
| Palladium Catalyst II | 5.0 wt-% palladium loading on silica (used to prepare a silane |
| | additive), available from Alfa Aesar (Tewksbury, MA, USA) |
| 1,1,3,3,5,5- | Reactant used to prepare a silane additive; available from Gelest, |
| hexamethyltrisiloxane | Incorporated (Morrisville, PA, USA) |

### Test Methods

### Silicone Coat Weight Procedure

Silicone coat weights were determined by comparing approximately 3.69 centimeter (cm) diameter samples of coated and uncoated substrates using an EDXRF spectrophotometer (obtained from Oxford Instruments (Elk Grove Village, Ill., USA) under trade designation OXFORD LAB X3000).

### Silicone Extractable Procedure

Unreacted silicone extractables were measured on cured thin film formulations to ascertain the extent of silicone crosslinking. The percent extractable silicone (i.e., the unreacted silicone extractables), a measure of the extent of silicone cure on a release liner, was measured by the following method. The silicone coat weight of a 3.69 cm diameter sample of coated substrate was determined according to the Silicone Coat Weight Procedure. The coated substrate sample was then immersed in and shaken with methyl isobutyl ketone (MIBK) for 5.0 minutes, removed, and allowed to dry. The silicone coating weight was measured again according to the Silicone Coat Weight Procedure. Silicone extractables were attributed to the weight difference between the silicone coat weight before and after extraction with MIBK as a percent using the following formula.

[(a−b)/a]*100=Percent Extractable Silicone

In this formula, the variable a refers to the initial coating weight (before extraction with MIBK) and variable b refers to the final coating weight (after extraction with MIBK).

### Initial Peel Adhesion Strength

Peel adhesion strength was measured at an angle of 180° using an IMASS SP-200 slip/peel tester (available from IMASS, Incorporated, Accord, Mass.) at a peel rate of 228.6 centimeters/minute (90 inches/minute). Stainless-steel panels measuring 25.4 centimeters by 12.7 centimeters (10 inches by 5 inches) were cleaned by wiping them with isopropanol using a lint-free tissue and allowing them to air dry for 30 minutes after which they were clamped to the test stage of the peel tester. Tape samples measuring approximately 2.6 centimeters by 20 centimeters (1.0 inch by 8 inches) were then applied to the cleaned test panels with the adhesive side in contact with the test panel. The tape samples were then rolled over using a 2.0-kilogram (4.5-pound) rubber roller one time in each direction. The taped panels were stored and tested at controlled temperature and humidity (CTH) (i.e., 23° C. and 50% RH (relative humidity)). Testing was conducted right away after preparation. Three to five taped panels were evaluated and the average peel adhesion strength of the total number of panels tested was reported. Results were obtained in grams/inch (g/in) and converted to Newtons/decimeter (N/dm). In addition, it was noted if any adhesive residue remained on the stainless-steel panel after removal of the tape sample.

### Release Force

The 180° angle release force of a release liner to an adhesive sample was measured in the following manner. TAPE 1, a three-layer tape sample construction, was prepared by following the preparation procedure and process listed for Ex. 1 of U.S. Pat. No. 9,556,367 (Waid et al.). TAPE 1 was applied to release liner constructions with the first skin adhesive of the tape in contact with the silicone coated surface of the release liner (see Preparation of Release Formulation, Coating, and Curing procedure below). The resulting laminates were then rolled over using a 2.0-kilogram (4.5-pound) rubber roller one time in each direction and aged for 7 days at 23° C. at 50% RH or 158° F. (70° C.) at 50% RH prior to testing for release adhesion strength.

Next, a double-sided foam tape (3M Double Coated Urethane Foam Tape 4008, a 0.125-inch-thick open-cell, flexible urethane foam tape, available from 3M Company, Maplewood, Minn.) was applied to the platen of a peel tester (Slip/Peel Tester, Model 3M90, available from Instrumentors, Incorporated, Strongsville, Ohio). A sample of the release liner/tape laminate, measuring 2.54 centimeters by approximately 20 centimeters (1 inch by 8 inches), was then applied to the exposed foam tape surface such that the exposed surface of the tape contacted the foam tape. This was rubbed down using light thumb pressure followed by rolling over it with a 2.0-kilogram (4.5-pound) rubber roller one time in each direction. The tape was then removed from the liner at an angle of 180° at a rate of 229 centimeters/minute (90 inches/minute). Results were obtained in grams/inch and converted to Newtons/decimeter (N/dm). Three to five laminates were evaluated and the average release adhesion strength of the total number of laminates tested was reported. All testing was performed at controlled temperature and humidity (CTH) (i.e., 70° F. (21° C.) and 50% RH). Release force results for samples aged for 7 days at CTH and in a 158° F. (70° C.) oven are summarized in Table 4 and Table 5, respectively.

### Re-Adhesion Peel Strength and % Retention of Initial Peel Strength

The effect of extractable materials in the release coating of the release liners on the peel adhesion strength of adhesive tapes which contacted the liners was evaluated as follows. After evaluating release liners for their release force, the tape was removed from the foam tape and evaluated for its re-adhesion peel strength as described in the Initial Peel Adhesion Strength test method above. The adhesive layer of the tape was applied to the stainless-steel test panel.

In addition, a tape sample not previously exposed to the release liners described herein was also evaluated for its peel adhesion strength according to the Initial Peel Adhesion Strength test method above. These results were recorded as “Initial Peel Adhesion Strength”. This test was a measure of the effect of any extractable transferred from the release liner to the adhesive layer of the tape on the peel adhesion strength of the tape. It is desirable that there be minimal differences between the initial and re-adhesion peel strength values. Re-adhesion peel strengths were used to calculate Percent Retention value as follows:

Percent Retention=(Re-adhesion Peel Strength/Initial Peel Adhesion Strength)×100.

### Method of Determining Molecular Weight

Molecular weights can be determined at 23° C. by gel permeation chromatography (GPC) using a Model AGILENT 1100 Series LC SYSTEM (Agilent Technologies, Santa Clara, Calif.) equipped with a JORDI Gel DVB (Divinyl Benzene) MB-LS (Mixed Bed-Light Scattering) 250 millimeter (length)×10 millimeter I.D. (Inside Diameter) column set, in combination with a Model WYATT REX DIFFERENTIAL REFRACTIVE INDEX DETECTOR and a Model WYATT HELEOS II 18 ANGLE STATIC LIGHT SCATTERING DETECTOR (Wyatt Technology Corporation, Santa Barbara, Calif.). Polymer sample solutions were prepared by adding 10 milliliters of tetrahydrofuran (THF) to a sample weighing approximately 50 to 100 milligrams and mixing for at least 14 hours followed by filtering through a 0.2 micrometer polytetrafluoroethylene syringe filter. The injection volume was 60 microliters and the THF eluent flow rate was 1.0 milliliter/minute. Duplicate solutions were run. The results were analyzed using Wyatt ASTRA software, Version 5.3.

### Method of Determining Volatile Content in Polymers

Typically, 50.0 grams of polymer is kept in an aluminum tray of the following dimension: (14×12×6 cm) at 150° C. in open air under the fume-hood for one hour. The weight percent volatile content was calculated by the following formula and reported in Table 2.

(x−y)/x*100=weight percentage volatiles

In this formula, the variable x is equal to the initial weight of polymer (before heating) and the variable y is equal to the final weight of polymer (after heating for one hour).

TABLE 2
Weight percentage volatiles in DMS-S12 Y01 and PMX-0930

| | Average Molecular | |
|---|---|---|
| Polymer | Weight (Mw), g/mole | Wt-% volatile |
| DMS-S12 Y01 | 700 | 84.2% |
| PMX-0930 | 2400 | 32.4% |

### Preparation of Additives

### Additive #1. Preparation of 1,3-Diethoxytetramethyldisiloxane

Anhydrous ethanol (94 grams) and palladium catalyst on activated charcoal (0.25 grams) were added at room temperature to a nitrogen purged 500 milliliters (mL) round bottom flask equipped with a condenser. Next, 1,3-tetramethyldisiloxane (134.32 grams) was added dropwise to the mixture for over an hour. The dropwise addition of 1,3-tetramethyldisiloxane led to an exothermic dehydrogenative coupling reaction. The temperature of the mixture was maintained between 70-80° C. by regulating the addition of 1,3-tetramethyldisiloxane. The reaction was monitored by ¹H NMR until the Si—H peak at 4.45 ppm disappeared. The reaction proceeded for 3-4 hours after the complete addition of 1,3-tetramethyldisiloxane. 1,3-diethoxytetramethyldisiloxane yield was calculated to be 95-99%.

### Additive #2. Preparation of 1,3-Dimethoxytetramethyldisiloxane

Methanol (65 grams) and palladium catalyst on activated charcoal (0.25 grams) were added at room temperature to a nitrogen purged 500 milliliters round bottom flask equipped with a condenser. Next, 1,3-tetramethyldisiloxane (134.32 grams) was added dropwise to the mixture for over two hours. The dropwise addition of 1,3-tetramethyldisiloxane led to an exothermic dehydrogenative coupling reaction. The temperature of the mixture was maintained between 60-70° C. by regulating the addition of 1,3-tetramethyldisiloxane. The reaction was monitored by ¹H NMR until the Si—H peak at 4.45 ppm disappeared. The reaction continued for an hour after the complete addition of 1,3-tetramethyldisiloxane. 1,3-dimethoxytetramethyldisiloxane yield was calculated to be 95-99%.

Additive #3. Preparation of 1,2-bis(dimethylethoxysilyl)ethane

Anhydrous ethanol (94 grams) and palladium catalyst on activated charcoal (0.25 grams) were added at room temperature to a nitrogen purged 500 milliliters round bottom flask equipped with a condenser. Next, 1,2-bis(dimethylsilyl)ethane (146 grams) was added dropwise to the mixture for over an hour. The dropwise addition of 1,2-bis(dimethylsilyl)ethane led to an exothermic dehydrogenative coupling reaction. The temperature of the mixture was maintained between 70-80° C. by regulating the addition of 1,2-bis(dimethylsilyl)ethane. The reaction was monitored by ¹H NMR until the Si—H peak at 4.32 ppm disappeared. The reaction continued for 2-3 hours after the complete addition of 1,2-bis(dimethylsilyl)ethane. 1,2-bis(dimethylethoxysilyl)ethane yield was calculated to be 95-99%.

Additive #4. Preparation of 1,2-bis(dimethylmethoxysilyl)ethane

Methanol (65 grams) and palladium catalyst on activated charcoal (0.25 grams) were added at room temperature to a nitrogen purged 500 milliliters round bottom flask equipped with a condenser. Next, 1,2-bis(dimethylsilyl)ethane (146 grams) was added dropwise to the mixture for over two hours. The dropwise addition of 1,2-bis(dimethylsilyl)ethane led to an exothermic dehydrogenative coupling reaction. The temperature of the mixture was maintained between 70-80° C. by regulating the addition of 1,2-bis(dimethylsilyl)ethane. The reaction was monitored by ¹H NMR until the Si—H peak at 4.32 ppm disappeared. The reaction continued for 2-3 hours after the complete addition of 1,2-bis(dimethylsilyl)ethane. 1,2-bis(dimethylmethoxysilyl)ethane yield was calculated to be 95-99%.

Additive #5. Preparation of 1,5 diethoxy 1,1,3,3,5,5-Hexamethyltrisiloxane

Anhydrous ethanol (47 grams) and palladium catalyst on activated charcoal (0.25 grams) were added at room temperature to a nitrogen purged 500 milliliters round bottom flask equipped with a condenser. Next, 1,1,3,3,5,5-hexamethyltrisiloxane (104 grams) was added dropwise to the mixture for over an hour. The dropwise addition of 1,1,3,3,5,5-hexamethyltrisiloxane led to an exothermic dehydrogenative coupling reaction. The temperature of the mixture was maintained between 70-80° C. by regulating the addition of 1,1,3,3,5,5-hexamethyltrisiloxane. The reaction was monitored by ¹H NMR until the Si—H peak at 4.60 ppm disappeared. The reaction continued for 4 hours after the complete addition of 1,1,3,3,5,5-hexamethyltrisiloxane. 1,5 diethoxy 1,1,3,3,5,5-hexamethyltrisiloxane yield was calculated to be 95-99%.

### Additive #6. Preparation of 1,5 Dimethoxy 1,1,3,3,5,5-Hexamethyltrisiloxane

Methanol (33 grams) and palladium catalyst on silica (0.25 grams) were added at room temperature to a nitrogen purged 500 milliliters round bottom flask equipped with a condenser. Next, 1,1,3,3,5,5-hexamethyltrisiloxane (104 grams) was added dropwise to the mixture for over two hours. The dropwise addition of 1,1,3,3,5,5-hexamethyltrisiloxane led to an exothermic dehydrogenative coupling reaction. The temperature of the mixture was maintained between 70-80° C. by regulating the addition of 1,1,3,3,5,5-hexamethyltrisiloxane. The reaction was monitored by ¹H NMR until the Si—H peak at 4.60 ppm disappeared. The reaction continued for an hour after the complete addition of 1,1,3,3,5,5-hexamethyltrisiloxane. 1,5 dimethoxy 1,1,3,3,5,5-hexamethyltrisiloxane yield was calculated to be 95-99%.

Additive #7. Preparation of (1, triethylsilyl 4, diethoxymethylsilyl) ethane

A mixture of vinylmethyldiethoxysilane (80 grams) and 0.121 grams of Karstedt's Catalyst was added at room temperature to a 500 milliliters round bottom flask equipped with a condenser, heated, and maintained at 80° C. for 30 minutes. Next, 58 grams of triethylsilane was added dropwise to the flask for over an hour. The reaction continued at 80° C. for 4 hours after the complete addition of triethylsilane. The reaction was monitored by ¹H NMR until the Si—H (4.35 ppm) and Si—CH═CH2 (5.1-6.5 ppm) peaks disappeared. (1, triethylsilyl 4, diethoxymethylsilyl) ethane yield was calculated to be 95-99%.

### EXAMPLES

### Preparation of Release Formulation, Coating, and Curing

Typically, materials listed in Table 3 were added to a 50 milliliters glass vial.

For Comparative Example CE1, which did not contain a silane additive, the mixture was cloudy and solid precipitated to the bottom of the vial. This mixture would not cure when exposed to UV radiation.

For Comparative Example CE2, more crosslinker was used rather than any silane additive to provide a reaction mixture that was transparent. For Examples EX1 to EX10, the mixtures were transparent after the addition of the silane additive. For CE2 and EX1 to EX10, after the addition of additives the mixtures turned completely transparent, thereafter a mixture of heptane/methyl ethyl ketone (80:20 w/w) was added to the solutions to make 25 wt-% solid solutions in solvents. Using a #8 Mayer rod, the mixtures were then coated individually onto a PET film (3SAB PET, 2-mil (50.8 micrometers) thick polyester terephthalate (PET) film, commercially available under the trade designation “HOSTAPHAN 3SAB” from Mitsubishi Polyester Film, Greer, S.C.). To cure, the coated film was passed through the “LIGHT HAMMER 6” UV-chamber (obtained from Fusion UV Systems, Inc. (Gaithersburg, Md., USA), under trade designation “LIGHT HAMMER 6”) equipped with an H-bulb located at 5.3 cm above the coated surface, at 12 meters/minute. The coating was cured to touch in one pass.

### Adhesive Lamination and E-Beam Process

The following comparative examples (CE) and examples (EX) were prepared to evaluate the release characteristics under conditions that would be used in the manufacturing process of transfer trapes and/or regular adhesive tapes. The examples simulate and evaluate the release characteristics of the release layer adjacent to the adhesive layer after E-Beam exposure.

Two different methods were used to evaluate the effect of E-Beam radiation having a dosage of 8 Mrads (Megarad) and an accelerating voltage of 275 keV (kiloelectron volts) on liner release forces. An Energy Sciences Inc. (ESI) ELECTROCURTAIN CB-300 E-Beam unit (Wilmington, Mass., USA) was used to treat the samples. Laminate samples of the adhesive tape with one side were prepared and tested under the following conditions:

(EX8-EX10) Condition 1: The coated side of the test liner was E-Beam treated. Then the E-Beam treated side of the test liner was immediately laminated to the adhesive side of the adhesive foam tape (prepared as in Example 1 of U.S. Pat. No. 9,556,367 (Waid et al.)) using a 4.5 lbs. (2.0 kg) roller.

(CE2, EX1-EX7) Condition 2: The coated side of the test liner was laminated to the adhesive side of the adhesive tape (prepared as in Example 1 of U.S. Pat. No. 9,556,367 (Waid et al.)) using a 4.5 lbs. (2.0 kg) roller. Then the laminate was E-beam treated on the non-coated (exposed) side of the test liner. E-Beam treatment were always carried out at a low oxygen level (i.e., less than 10 parts per million (ppm), typically less than 2.5 ppm).

TABLE 3
Release liner formulation and extractable details

| | | | | Additive | | | Extract- |
|---|---|---|---|---|---|---|---|
| | PMX- | XL- | PAG, | Addi- | Addi- | XG- | able sil- |
| Example | 093, g | 1, g | G | tive # | tive, g | 2509, g | icone, % |
| CE1 | 4.4 | 0.48 | 0.12 | N/A | 0.0 | 0.0 | N/A |
| CE2 | 4.4 | 1.06 | 0.12 | N/A | 0.0 | 0.0 | 3.84 |
| EX1 | 4.4 | 0.48 | 0.12 | 1 | 1.0 | 0.0 | 1.65 |
| EX2 | 4.4 | 0.48 | 0.12 | 2 | 0.75 | 0.0 | 2.05 |
| EX3 | 4.4 | 0.48 | 0.12 | 3 | 0.75 | 0.0 | 4.38 |
| EX4 | 4.4 | 0.48 | 0.12 | 4 | 0.63 | 0.0 | 5.43 |
| EX5 | 4.4 | 0.48 | 0.12 | 5 | 1.50 | 0.0 | 1.96 |
| EX6 | 4.4 | 0.48 | 0.12 | 6 | 1.12 | 0.0 | 3.47 |
| EX7 | 4.4 | 0.48 | 0.12 | 7 | 0.75 | 0.0 | 2.25 |
| EX8 | 2.33 | 0.46 | 0.14 | 1 | 1.07 | 0.86 | 4.63 |
| EX9 | 2.69 | 0.46 | 0.14 | 3 | 0.90 | 0.86 | 6.89 |
| EX10 | 2.86 | 0.46 | 0.14 | 4 | 0.72 | 0.86 | 8.34 |

TABLE 4
Release and Re-adhesion results under CTH (constant
temperature and relative humidity conditions:
70° F. (21° C.) and 50% Relative Humidity)

| | | Initial Peel | Re-adhesion | |
|---|---|---|---|---|
| | Release | Adhesion | Peel | Retention of |
| | Force, | Strength, | Strength, | Initial Peel |
| | g/in | g/in | g/in | Adhesion |
| Example | (N/dm) | (N/dm) | (N/dm) | Strength, % |
| CE2 | 224 | 3677 | 3605 | 98 |
| | (103) | (4045) | (3965) | |
| EX 1 | 80 | 3677 | 3602 | 98 |
| | (88) | (4045) | (3962) | |
| EX 2 | 86 | 3677 | 3616 | 98 |
| | (94) | (4045) | (3978) | |
| EX 3 | 80 | 3677 | 3898 | 106 |
| | (88) | (4045) | (4288) | |
| EX 4 | 70 | 3677 | 3670 | 100 |
| | (77) | (4045) | (4037) | |
| EX 5 | 68 | 3677 | 4877 | 133 |
| | (75) | (4045) | (5364) | |
| EX 6 | 57 | 3677 | 3475 | 95 |
| | (63) | (4045) | (3823) | |
| EX 7 | 81 | 3677 | 3569 | 97 |
| | (89) | (4045) | (3926) | |
| EX 8 | 81 | 3310 | 3634 | 110 |
| | (89) | (3641) | (3998) | |
| EX 9 | 60 | 3310 | 3588 | 108 |
| | (65) | (3641) | (3947) | |
| EX 10 | 72 | 3310 | 3473 | 105 |
| | (79) | (3641) | (3820) | |

TABLE 5
Release and Re-adhesion results at 158° F. (70° C.)

| | | Initial Peel | Re-adhesion | |
|---|---|---|---|---|
| | Release | Adhesion | Peel | Retention of |
| | Force, | Strength, | Strength, | Initial Peel |
| | g/in | g/in | g/in | Adhesion |
| Example | (N/dm) | (N/dm) | (N/dm) | Strength, % |
| CE2 | N/A* | N/A* | N/A* | N/A* |
| EX1 | 503 | 3501 | 2939 | 84 |
| | (553) | (3851) | (3233) | |
| EX2 | 577 | 3501 | 2955 | 84 |
| | (635) | (3851) | (3251) | |
| EX3 | 327 | 3501 | 2772 | 79 |
| | (360) | (3851) | (3049) | |
| EX4 | 380 | 3501 | 3068 | 88 |
| | (418) | (3851) | (3375) | |
| EX5 | 422 | 3501 | 3127 | 89 |
| | (464) | (3851) | (3440) | |
| EX6 | 355 | 3501 | 3523 | 101 |
| | (390) | (3851) | (3876) | |
| EX7 | 148 | 3501 | 3436 | 98 |
| | (163) | (3851) | (3780) | |
| EX8 | 78 | 3248 | 2895 | 89 |
| | (86) | (3573) | (3184) | |
| EX9 | 66 | 3248 | 3434 | 106 |
| | (72) | (3573) | (3777) | |
| EX10 | 77 | 3248 | 3609 | 111 |
| | (85) | (3573) | (3970) | |

N/A* means that the release layer could not be separated from adhesive layer

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A curable release composition comprising:
a) a siloxane polymer of Formula (I) 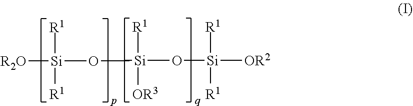
having a weight average molecular weight of at least 1000 Daltons wherein
R¹ is alkyl; and
R² is hydrogen or alkyl;
R³ is alkyl;
p is an integer equal to at least 10; and
q is an integer in a range of 0 to 0.1(p);
b) a crosslinker of Formula (II)
(OR⁵)₃₋ₓ(R⁴)ₓSi—R⁸—Si(R⁴)ₓ(OR⁵)₃₋ₓ II
wherein
R⁴ is alkyl or aryl;
R⁵ is alkyl;
R⁸ is oxy, a group of formula —O—[Si(CH₃)₂—O]ₘ—, an alkylene, a heteroalkylene, a heteroalkylene substituted with a hydroxyl group, an arylene, a fluorine substituted arylene, or an alkylene-arylene-alkylene group;
m is an integer in a range of 1 to 10; and
x is an integer equal to 0 or 1;
c) a silane additive having two silyl groups of formula —Si(R⁶)₂(OR⁷) or
having a single silyl group of formula —Si(R¹⁰)(OR⁹)₂ wherein
R⁶ is alkyl or aryl;
R⁷ is alkyl;
R⁹ is alkyl;
R¹⁰ is alkyl or aryl; and
d) a photoacid generator; and
e) an optional silicate resin.

2. (canceled)

3. The article of claim 1, wherein the silane additive is of Formula (III)
(R⁷O)(R⁶)₂Si—R¹¹—Si(R⁶)₂(OR⁷) (III)
wherein
R¹ is oxy, a group of formula —O—[Si(CH₃)₂—O]ₙ—, an alkylene, an arylene, a fluorinated arylene, or an alkylene-arylene-alkylene group; and
n is an integer in a range of 1 to 10.

4. The article of claim 1, wherein the silane additive is of Formula (IV)
R¹²—Si(R¹⁰)(OR⁹)₂ (IV)
wherein
R⁹ is alkyl;
R¹⁰ is alkyl or aryl; and
R¹² is alkyl, aryl, or a group of formula —R¹³—Si(R¹⁴)₃ where R¹³ is an alkylene and each R¹⁴ is independently an alkyl.

5. The article of claim 1, wherein the curable release composition comprises 20 to 95 weight percent siloxane polymer, 1 to 20 weight percent crosslinker, 1 to 50 weight percent silane additive, 0.25 to 10 weight percent photoacid generator, and 0 to 40 weight percent silicate resin.

6. An article comprising:
a) a backing layer having a first major surface and a second major surface opposite the first major surface; and
b) a first release layer adjacent to the first major surface of the backing layer, wherein the first release layer comprises a first cured reaction product of a first curable release composition comprising
i) a first siloxane polymer of Formula (I) 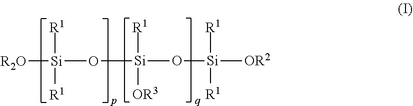
having a weight average molecular weight of at least 1000 Daltons wherein
R¹ is alkyl; and
R² is hydrogen or an alkyl;
R³ is alkyl;
p is an integer equal to at least 10; and
q is an integer in a range of 0 to 0.1(p);
ii) a first crosslinker is a compound of Formula (II)
(OR⁵)₃₋ₓ(R⁴)ₓSi—R⁸—Si(R⁴)ₓ(OR⁵)₃₋ₓ II
wherein
R⁴ is alkyl or aryl;
R⁵ is alkyl;
R⁸ is oxy, a group of formula —O—[Si(CH₃)₂—O]ₘ—, an alkylene, a heteroalkylene, a heteroalkylene substituted with a hydroxyl group, an arylene, a fluorine substituted arylene, or an alkylene-arylene-alkylene group;
m is an integer in a range of 1 to 10; and
x is an integer equal to 0 or 1;
iii) a first silane additive having two silyl groups of formula —Si(R⁶)₂(OR⁷) or
having a single silyl group of formula —Si(R¹⁰)(OR⁹)₂ wherein
R⁶ is alkyl or aryl;
R⁷ is alkyl;
R⁹ is alkyl;
R¹⁰ is alkyl or aryl; and
iv) a first photoacid generator; and
v) an optional first silicate resin.

7. The article of claim 6, further comprising an adhesive layer adjacent to the second major surface of the backing layer.

8. The article of claim 6, further comprising a second release layer adjacent to the second major surface of the backing layer wherein the second release layer comprises a second cured reaction product of a second curable release composition comprising
i) a second siloxane polymer of Formula (I); 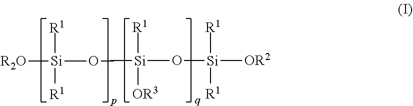
ii) a second crosslinker that is a compound of formula Si(OR⁵)₄ or is a compound having at least two silyl groups of formula —Si(R⁴)ₓ(OR⁵)₃₋ₓ;
iii) a second silane additive having two silyl groups of formula —Si(R⁶)₂(OR⁷) or having a single silyl group of formula —Si(R¹⁰)(OR⁹)₂;
iv) a second photoacid generator; and
v) a second silicate resin, wherein the amount of the second silicate resin in the second release layer is greater than the amount of the first silicate resin in the first release layer.

9. The article of claim 8, further comprising an adhesive layer adjacent to the second release layer opposite the backing layer.

10. The article of claim 9, wherein the adhesive layer is a first layer of a multilayer adhesive.

11. A method of making an article, the method comprising:
providing a backing having a first major surface and second major surface opposite the first major surface; and
applying a first curable release composition adjacent to the first major surface of the backing, wherein the first curable release composition comprises
i) a first siloxane polymer of Formula (I) 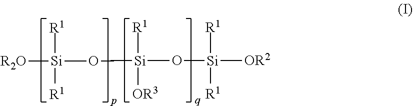
having a weight average molecular weight of at least 1000 Daltons wherein
R¹ is alkyl; and
R² is hydrogen or alkyl;
R³ is alkyl;
p is an integer equal to at least 10; and
q is an integer in a range of 0 to 0.1(p);
ii) a first crosslinker is a compound of Formula (II)
(OR⁵)₃₋ₓ(R⁴)ₓSi—R⁸—Si(R⁴)ₓ(OR⁵)₃₋ₓ II
wherein
R⁴ is alkyl or aryl;
R⁵ is alkyl;
R⁸ is oxy, a group of formula —O—[Si(CH₃)₂—O]ₘ—, an alkylene, a heteroalkylene, a heteroalkylene substituted with a hydroxyl group, an arylene, a fluorine substituted arylene, or an alkylene-arylene-alkylene group;
m is an integer in a range of 1 to 10; and
x is an integer equal to 0 or 1;
iii) a first silane additive having two silyl groups of formula —Si(R⁶)₂(OR⁷)
or having a single silyl group of formula —Si(R¹⁰)(OR⁹)₂ wherein
R⁶ is alkyl or aryl;
R⁷ is alkyl;
R⁹ is alkyl;
R¹⁰ is alkyl or aryl;
iv) a first photoacid generator; and
v) an optional first silicate resin;
exposing the first curable release composition to ultraviolet radiation or electron beam radiation to form a first release layer.

12. The method of claim 11, further comprising positioning a curable adhesive layer adjacent to the second major surface of the backing layer and forming a cured adhesive layer by exposing the curable adhesive layer to electron beam radiation with the electron beam radiation passing through the first release layer and the backing prior to reaching the curable adhesive layer.

13. The method of claim 11, further comprising applying a second curable release composition adjacent to the second major surface of the backing, wherein the second curable release composition comprises
i) a second siloxane polymer of Formula (I); 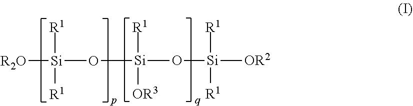
ii) a second crosslinker is a compound of formula Si(OR⁵)₄ or is a compound having at least two silyl groups of formula —Si(R⁴)ₓ(OR⁵)₃₋ₓ;
iii) a second silane additive having two silyl groups of formula —Si(R⁶)₂(OR⁷) or having a single silyl group of formula —Si(R¹⁰)(OR⁹)₂;
iv) a second photoacid generator; and
v) a second silicate resin.

14. The method of claim 13, further comprising positioning a curable adhesive layer adjacent to the second release layer opposite the backing layer and forming a cured adhesive layer by exposing the curable adhesive layer to electron beam radiation with the electron beam radiation passing through the first release layer, the backing, and the second release layer prior to reaching the curable adhesive layer.
